(19) United States
(12) Patent Application Publication
(10) Pub. No.: US 2023/0368305 A1
(43) Pub. Date: Nov. 16, 2023

(54) INFORMATION PROCESSING APPARATUS, INFORMATION PROCESSING METHOD, PROGRAM, INFORMATION PROCESSING TERMINAL, AND INFORMATION PROCESSING SYSTEM

(71) Applicant: SONY GROUP CORPORATION, TOKYO (JP)

(72) Inventors: YUKI OKAMURA, TOKYO (JP); TAIZO SHIRAI, KANAGAWA (JP); HAJIME FUKUI, TOKYO (JP)

(21) Appl. No.: 18/245,547

(22) PCT Filed: Sep. 22, 2021
(86) PCT No.: PCT/JP2021/034832

§ 371 Date: Mar. 16, 2023

(30) Foreign Application Priority Data
Oct. 5, 2020 (JP) 2020-168187

(51) Int. Cl. G06Q 40/08; G01C 21/34

(52) U.S. Cl. CPC G06Q 40/08; G01C 21/3415

(57) ABSTRACT

The present technology relates to an information processing apparatus, an information processing method, a program, an information processing terminal, and an information processing system capable of providing an insurance applicable to a service using a mobility as a service (MaaS). The information processing system includes the information processing apparatus, and the information processing terminal, in which the information processing apparatus includes an insurance money calculator that calculates insurance money on the basis of a contract content of an insurance that compensates for damage occurring on a route combining a plurality of mobility means and on the basis of actual damage, and a first communication controller that controls communication with the information processing terminal, and the information processing terminal includes a second communication controller that controls communication with the information processing apparatus, and a user interface controller that controls presentation of the insurance money calculated by the information processing apparatus. The present technology is applicable to, for example, a system that provides an insurance applied to a service using MaaS.

### TECHNICAL FIELD

The present technology relates to an information processing apparatus, an information processing method, a program, an information processing terminal, and an information processing system, and particularly, to an information processing apparatus, an information processing method, a program, an information processing terminal, and an information processing system capable of providing an insurance applicable to a service using a mobility as a service (MaaS).

### BACKGROUND ART

Conventionally, an information processing technology related to a pay-as-you-go automobile insurance has been studied in which an application for use is made and an insurance premium is paid for every use without limiting an automobile to be a subject in advance (see, for example, Patent Document 1.).

Furthermore, in recent years, a mobility as a service (MaaS) has been attracting more and more attention. Here, in the Ministry of Land, Infrastructure, Transport and Tourism in Japan, MaaS is defined as a new concept of “mobility” that utilizes information and communication technology (ICT) to cloud transportation, perceives mobility by all transportation means other than a private car as one service and seamlessly connects the transportation, regardless of whether or not the transportation is public and regardless of an operating entity of the transportation.

### CITATION LIST

### Patent Document

Patent Document 1: Japanese Patent Application Laid-Open No. 2014-149882

### SUMMARY OF THE INVENTION

### Problems to be Solved by the Invention

In the future, with the spread of services using MaaS, it is assumed that demand for insurance applicable to services using MaaS increases.

The present technology has been made in view of such a situation, and an object of the present technology is to provide an insurance applicable to a service using MaaS.

### Solutions to Problems

An information processing apparatus according to a first aspect of the present technology includes an insurance money calculator that calculates insurance money on the basis of a contract content of an insurance that compensates for damage occurring on a route combining a plurality of mobility means and on the basis of actual damage.

An information processing method according to the first aspect of the present technology includes calculating, by an information processing apparatus, insurance money on the basis of a contract content of an insurance that compensates for damage occurring on a route combining a plurality of mobility means and on the basis of actual damage.

A program according to the first aspect of the present technology causes a computer to execute processing including calculating insurance money on the basis of a contract content of an insurance that compensates for damage occurring on a route combining a plurality of mobility means and on the basis of actual damage.

In the first aspect of the present technology, the insurance money is calculated on the basis of the contract content of the insurance that compensates for the damage occurring on the route combining the plurality of mobility means and on the basis of the actual damage.

An information processing apparatus according to a second aspect of the present technology includes a communication controller that controls communication with an information processing apparatus that calculates insurance money on the basis of a contract content of an insurance that compensates for damage occurring on a route combining a plurality of mobility means and on the basis of actual damage, and a user interface controller that controls presentation of the insurance money calculated by the information processing apparatus.

An information processing method according to the second aspect of the present technology includes controlling, by an information processing terminal, communication with an information processing apparatus that calculates insurance money on the basis of a contract content of an insurance that compensates for damage occurring on a route combining a plurality of mobility means and on the basis of actual damage, and controlling, by the information processing terminal, presentation of the insurance money calculated by the information processing apparatus.

A program according to the second aspect of the present technology causes a computer to execute processing including controlling communication with an information processing apparatus that calculates insurance money on the basis of a contract content of an insurance that compensates for damage occurring on a route combining a plurality of mobility means and on the basis of actual damage, and controlling presentation of the insurance money calculated by the information processing apparatus.

In the second aspect of the present technology, the communication with the information processing apparatus that calculates the insurance money on the basis of the contract content of the insurance that compensates for the damage occurring on the route combining the plurality of mobility means and on the basis of the actual damage is controlled, and the presentation of the insurance money calculated by the information processing apparatus is controlled.

An information processing system according to a third aspect of the present technology includes an information processing apparatus, and an information processing terminal, in which the information processing apparatus includes an insurance money calculator that calculates insurance money on the basis of a contract content of an insurance that compensates for damage occurring on a route combining a plurality of mobility means and on the basis of actual damage, and a first communication controller that controls communication with the information processing terminal, and the information processing terminal includes a second communication controller that controls communication with the information processing apparatus, and a user interface controller that controls presentation of the insurance money calculated by the information processing apparatus.

In the third aspect of the present technology, the insurance money is calculated by the information processing apparatus on the basis of the contract content of the insurance that compensates for the damage occurring on the route combining the plurality of mobility means and on the basis of the actual damage, the communication with the information terminal is controlled by the information processing apparatus, the communication with the information processing apparatus is controlled by the information processing terminal, the presentation of the insurance money calculated by the information processing apparatus is controlled by the information processing terminal.

### BRIEF DESCRIPTION OF DRAWINGS

FIG. 1 is a block diagram illustrating a configuration example of an information processing system to which the present technology is applied.

FIG. 2 is a block diagram illustrating a configuration example of a server.

FIG. 3 is a block diagram illustrating a configuration example of a user terminal.

FIG. 4 is a flowchart for describing service use application processing.

FIG. 5 is a diagram illustrating a display example of a route proposal and an insurance plan.

FIG. 6 is a flowchart for describing service use application reception processing.

FIG. 7 is a flowchart for describing details of insurance premium calculation processing.

FIG. 8 is a flowchart for describing a first embodiment of service use processing.

FIG. 9 is a flowchart for describing a first embodiment of service providing processing.

FIG. 10 is a flowchart for describing details of reroute processing.

FIG. 11 is a flowchart for describing details of reschedule processing.

FIG. 12 is a flowchart for describing a specific example of the reroute processing.

FIG. 13 is a flowchart for describing insurance money claim processing.

FIG. 14 is a flowchart for describing insurance claim response processing.

FIG. 15 is a flowchart for describing details of compensation subject determination processing.

FIG. 16 is a flowchart for describing details of insurance money calculation processing.

FIG. 17 is a flowchart for describing a second embodiment of the service use processing.

FIG. 18 is a flowchart for describing the second embodiment of the service use processing.

FIG. 19 is a flowchart for describing a second embodiment of the service providing processing.

### MODE FOR CARRYING OUT THE INVENTION

Hereinafter, embodiments for implementing the present technology will be described. The description will be made in the following order.
1. Embodiments
2. Modifications
3. Others

### 1. Embodiments

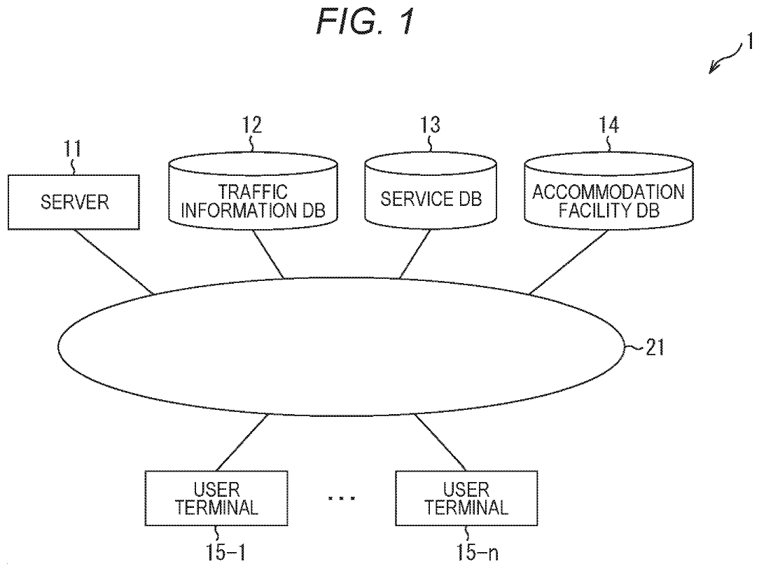

The embodiments of the present technology will be described with reference to FIGS. 1 to 19.

<Configuration Example of Information Processing System>

FIG. 1 shows a configuration example of an information processing system 1 to which the present technology is applied.

The information processing system 1 is a system for providing and using a service using a mobility as a service (MaaS) (hereinafter referred to as MaaS service) and a property insurance (hereinafter referred to as MaaS insurance) applicable to the MaaS service.

The MaaS service includes, for example, a service of setting and changing a route from a departure place to a destination, arranging a mobility means within the route, and the like on the basis of a schedule of a user, an operation status of various mobility means, a congestion status of roads in each place, and the like. Furthermore, the MaaS service includes, for example, a service of changing a schedule of the user, a service of changing a service planned to be used and an accommodation facility, and the like.

Note that a type of mobility means available in the MaaS service is not limited. For example, the mobility means includes public transportation with a determined route, such as a train, an airplane, a route bus, and a ship, transportation without a determined route, such as a taxi and a motorbike taxi, and a mobility means by the user's own driving and the like, such as a private car, a rental car, a motorcycle, a bicycle, and walking.

The MaaS insurance is a property insurance that compensates for (covers) damage occurring during use of the MaaS service, that is, on a route set in the MaaS service and combining a plurality of mobility means. The damage occurring during the use of the MaaS service includes at least one of damage occurring due to an accident (for example, a traffic accident, an injury, a theft, or the like) of an insured person who uses the MaaS service or damage occurring due to a delay of a mobility means.

Hereinafter, an insurance that compensates for the former is referred to as an accident compensation insurance, and an insurance that compensates for the latter is referred to as a delay compensation insurance. A policyholder can contract both types of insurance, or can contract only one type of insurance.

Note that a policyholder and an insured person of the MaaS insurance may be the same or different. Hereinafter, a case will be described where the policyholder and the insured person of the MaaS insurance are the same, and the policyholder and the insured person of the MaaS insurance are referred to as a user. Note that the user is also a person who uses the MaaS service.

Furthermore, hereinafter, a case where the user uses the delay compensation insurance will be mainly described as an example.

The information processing system 1 includes a server 11, a traffic information database (DB) 12, a service database (DB) 13, an accommodation facility database (DB) 14, and user terminals 15-1 to 15-n. The server 11, the traffic information DB 12, the service DB 13, the accommodation facility DB 14, and the user terminals 15-1 to 15-n are mutually connected via a network 21.

Note that, hereinafter, in a case where not being required to be individually distinguished, the user terminals 15-1 to 15-n are simply referred to as a user terminal 15.

The server 11 is an information processing apparatus that is used by a service provider who is a corporation or the like that provides the MaaS service and the MaaS insurance, the apparatus performing various information processing related to the MaaS service and the MaaS insurance.

The traffic information DB 12 is a database that stores various information related to traffic. For example, the traffic information DB 12 stores information regarding a traffic network available to the user and information regarding a status of roads. The information regarding the traffic network includes, for example, information regarding routes, timetables, fees, operation statuses, reservation statuses, and the like of various mobility means. The information regarding the operation status of the mobility means includes, for example, delay information (including information regarding operation stop), information regarding a congestion status, and the like. The information regarding roads includes, for example, congestion information, information regarding a closed section, a restricted passage section, and a construction implementation section, and the like.

The service DB 13 is a database that stores information regarding services available to the user. The service available to the user includes, for example, any services (except accommodation) such as a tour, an event, food and drink, medical care, and education. In addition, the service DB 13 stores, for example, information regarding content, a schedule, a location, business hours, equipment, a fee, a reservation status, and the like of various services.

The accommodation facility DB 14 is a database that stores information regarding accommodation facilities available to the user. The accommodation facility DB 14 stores, for example, information regarding a location, equipment, service, a fee, check in time, check out time, a reservation status, and the like of each accommodation facility.

The user terminal 15 is an information processing terminal used by the user who uses the MaaS service and the MaaS insurance, and includes, for example, a smartphone, a tablet terminal, a mobile phone, a personal computer (PC), or the like. Note that one user can also use a plurality of user terminals 15.

<Configuration Example of Server 11>

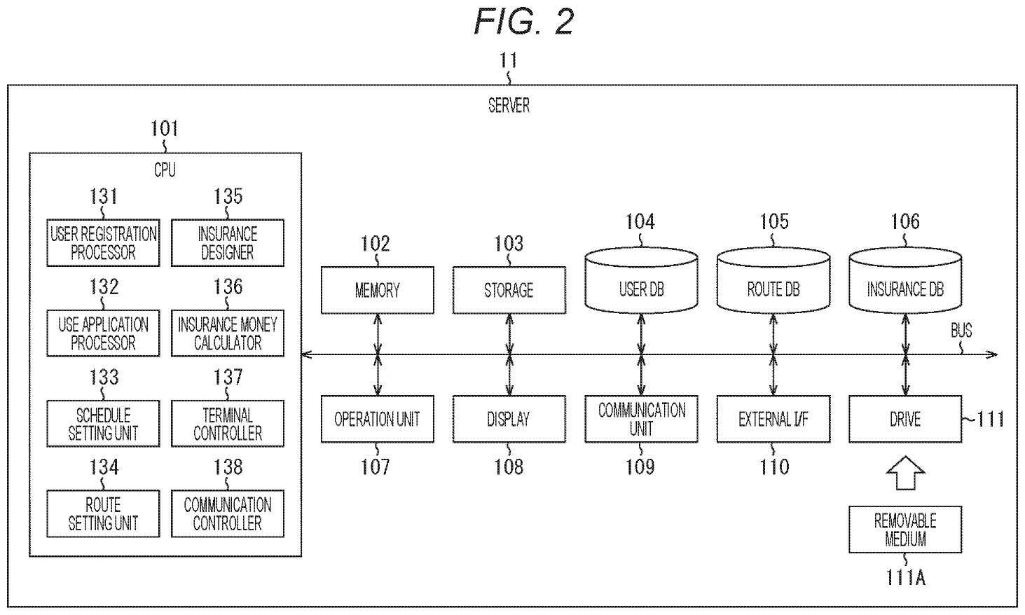

FIG. 2 is a block diagram illustrating a configuration example of the server 11 shown in FIG. 1.

The server 11 includes a central processing unit (CPU) 101, a memory 102, a storage 103, a user DB 104, a route DB 105, an insurance DB 106, an operation unit 107, a display 108, a communication unit 109, an external I/F 110, and a drive 111. The CPU 101 to the drive 111 are connected to a bus and perform necessary communication with each other.

The CPU 101 performs various processing by executing programs installed in the memory 102 and the storage 103.

The memory 102 includes, for example, a volatile memory or the like, and temporarily stores the program executed by the CPU 101 and necessary data.

The storage 103 includes, for example, a hard disk or a nonvolatile memory, and stores the program executed by the CPU 101 and necessary data.

The user DB 104 is a database that stores information regarding a user who uses the MaaS service and the MaaS insurance. For example, the user DB 104 stores personal information and authentication data of each user, contract contents and use histories of the MaaS service and the MaaS insurance, and the like.

The route DB 105 is, for example, a database that stores information, algorithms, and the like necessary for creating a route in the MaaS service.

The insurance DB 106 is a database that stores information, algorithms, and the like necessary for a design of the MaaS insurance and calculation of insurance money. The information necessary for the design of the MaaS insurance includes, for example, information regarding a delay of various mobility means, a probability of occurrence of an accident or the like, an expected value of a delay time, a probability of occurrence of traffic congestion in each place, an expected value of a traffic congestion amount, and the like.

The operation unit 107 includes physical keys (including a keyboard), a mouse, a touch panel, and the like. The operation unit 107 outputs an operation signal corresponding to an operation of a user on the bus in response to the operation of the user.

The display 108 includes, for example, a liquid crystal display (LCD) or the like, and displays an image in accordance with data fed from the bus.

Here, for example, the touch panel as the operation unit 107 includes a transparent member and can be integrally constituted with the display 108. As a result, the user can input information by operating an icon, a button, or the like displayed on the display 108.

The communication unit 109 includes a communication circuit, an antenna, and the like, and communicates with the traffic information DB 12, the service DB 13, the accommodation facility DB 14, the user terminal 15, and the like via the network 21 or not via the network 21.

The external interface (I/F) 110 is an interface for exchanging data with various external devices.

The drive 111 can attach and detach a removable medium 111A such as a memory card, for example, and drives the removable medium 111A attached to the drive 111.

In the server 11 configured as described above, the program executed by the CPU 101 can be recorded in advance in the storage 103 as a recording medium built in the CPU 101.

Furthermore, the program can be stored (recorded) in the removable medium 111A, provided as so-called package software, and installed from the removable medium 111A to the server 11.

In addition, the program can be downloaded from a server (not shown) or the like via the network 21 and the communication unit 109 and installed in the server 11.

The CPU 101 executes the program installed in the server 11 to implement a user registration processor 131, a use application processor 132, a schedule setting unit 133, a route setting unit 134, an insurance designer 135, an insurance money calculator 136, a terminal controller 137, and a communication controller 138.

The user registration processor 131 performs user registration processing of a user who uses the MaaS service and the MaaS insurance.

The use application processor 132 performs processing of responding to a use application of the MaaS service and the MaaS insurance from the user.

The schedule setting unit 133 registers a schedule created by the user. Furthermore, in a case where the execution of the schedule of the user is hindered by a route change (hereinafter referred to as rerouting), the schedule setting unit 133 performs processing (hereinafter referred to as schedule change processing) related to a schedule change (hereinafter referred to as a rescheduling) as necessary. For example, the schedule setting unit 133 performs processing related to cancellation of a service and an accommodation facility planned to be used by the user (hereinafter referred to as cancel processing). Furthermore, for example, the schedule setting unit 133 suggests an alternative plan of the canceled service and accommodation facility, and performs processing related to arrangement of a new service and accommodation facility (hereinafter referred to as arrangement processing).

The route setting unit 134 performs setting processing of a route used by the user in the MaaS service. For example, the route setting unit 134 creates a route proposal on the basis of the schedule of the user and suggests the route proposal to the user. The route setting unit 134 performs arrangement processing for mobility means within the route so that the user can travel in accordance with the route selected by the user. In addition, the route setting unit 134 performs rerouting as necessary on the basis of, for example, an operation status of each mobility means and the like. The route setting unit 134 performs cancel processing for the mobility means within the route before the rerouting and the arrangement processing for the mobility means within the route after the rerouting as necessary.

The insurance designer 135 performs processing of designing the MaaS insurance proposed to the user and calculating the insurance money to be paid by the user on the basis of the information stored in the user DB 104 to the insurance DB 106, the schedule, the route, and the like of the user.

The insurance money calculator 136 calculates an insurance premium to be paid to the user on the basis of the contract content of the MaaS insurance with which the user has a contract and the actual damage that has occurred during the use of the MaaS service.

The terminal controller 137 communicates with the user terminal 15 via the communication unit 109 and the network 21, and mainly controls a user interface in the user terminal 15.

The communication controller 138 controls communication by the communication unit 109.

Note that, in a case where each unit of the server 11 communicates with the traffic information DB 12, the service DB 13, the accommodation facility DB 14, the user terminal 15, and the like via the communication unit 109 and the network 21, the description of “via the communication unit 109 and the network 21” will be omitted. For example, in a case where the user registration processor 131 communicates with the user terminal 15 via the communication unit 109 and the network 21, it is simply described that the user registration processor 131 communicates with the user terminal 15.

<Configuration Example of User Terminal 15>

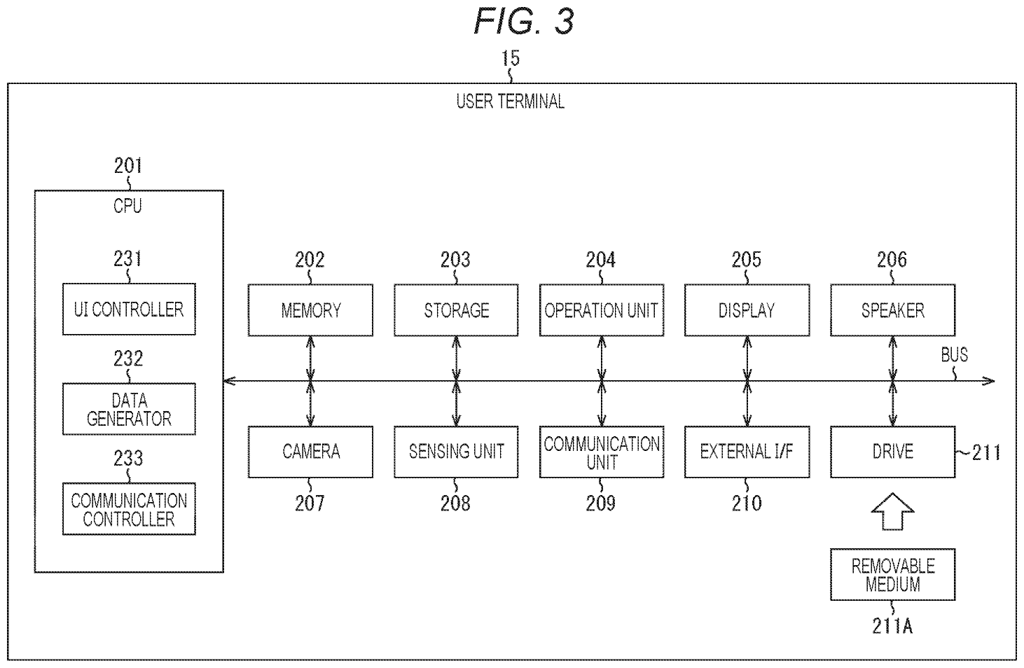

FIG. 3 is a block diagram illustrating a configuration example of the user terminal 15.

The user terminal 15 includes a CPU 201, a memory 202, a storage 203, an operation unit 204, a display 205, a speaker 206, a camera 207, a sensing unit 208, a communication unit 209, an external I/F 210, and a drive 211. The CPU 201 to the drive 211 are connected to a bus and perform necessary communication with each other.

The CPU 201 to the storage 203, the operation unit 204, the display 205, and the communication unit 209 to the drive 211 are configured similarly to the CPU 101 to the storage 103, the operation unit 107, the display 108, and the communication unit 109 to the drive 111 in FIG. 2, respectively.

The speaker 206 outputs sound in accordance with data fed from the bus.

The camera 207 captures an image (still image and moving image) (senses light) and outputs corresponding image data onto the bus.

The sensing unit 208 includes various sensors, and outputs sensor data output from each sensor on the bus. The sensing unit 208 includes, for example, a sensor for detecting a behavior of the user, for example, a global navigation satellite system (GNSS) receiver, an acceleration sensor, an angular velocity sensor, and the like.

In the user terminal 15, similarly to the server 11, the program executed by the CPU 201 can be recorded in advance in the storage 203 as a recording medium built in the user terminal 15.

Furthermore, the program can be stored (recorded) in a removable medium 211A, provided as package software, and installed from the removable medium 211A to the user terminal 15.

In addition, the program can be downloaded from a server (not shown) or the like via the network 21 and the communication unit 209 and installed in the user terminal 15.

The CPU 201 can function as a UI controller 231, a data generator 232, and a communication controller 233 by executing the program installed in the user terminal 15.

The UI controller 231 controls a user interface using the display 205, the speaker 206, and the like.

The data generator 232 generates various data necessary for use of the MaaS service and the MaaS insurance. For example, the data generator 232 generates behavior history data indicating a behavior of the user using the MaaS service, and insurance money claim data necessary for claiming the insurance money of the MaaS insurance.

The communication controller 233 controls communication by the communication unit 209.

Note that, in a case where each unit of the user terminal 15 communicates with the server 11, the traffic information DB 12, the service DB 13, the accommodation facility DB 14, the other user terminals 15, and the like via the communication unit 209 and the network 21, the description of “via the communication unit 209 and the network 21” will be omitted. For example, in a case where the UI controller 231 communicates with the server 11 via the communication unit 209 and the network 21, it is simply described that the UI controller 231 communicates with the server 11.

<Processing of Information Processing System 1>

Next, processing of the information processing system 1 will be described.

<Service Use Application Processing>

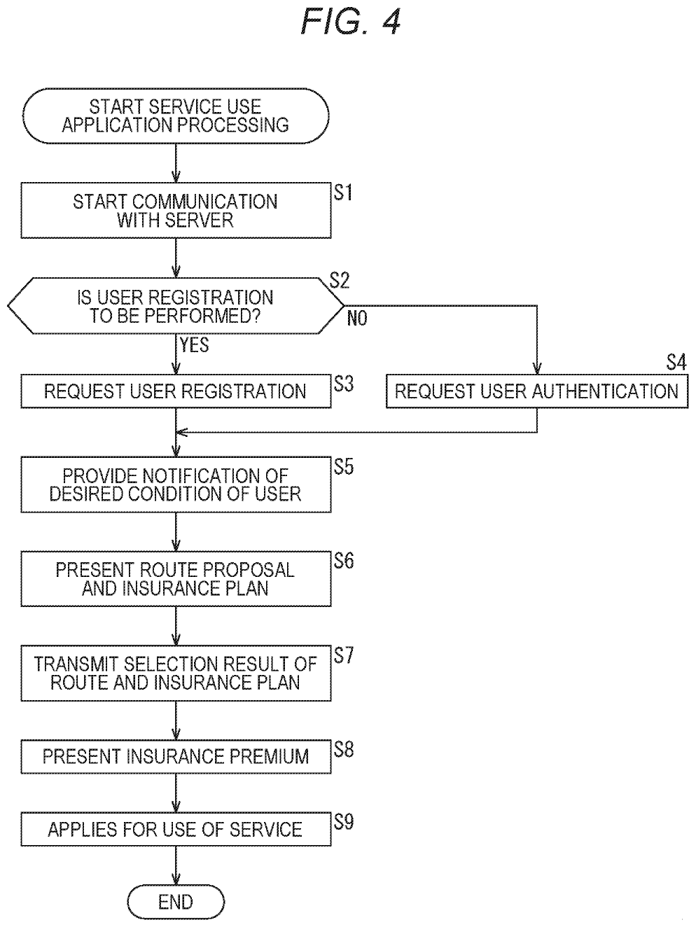

First, service use application processing executed by the user terminal 15 will be described with reference to a flowchart of FIG. 4.

This processing is started, for example, in a case where the user performs an operation for applying for the use of the MaaS service and the MaaS insurance by using the operation unit 204.

In step S1, the communication unit 209 starts communication with the server 11 via the network 21 under the control of the communication controller 233.

The UI controller 231 starts processing of causing the display 205 to display a user interface for applying for the use of the MaaS service and the MaaS insurance on the basis of the data received by the communication with the server 11.

Alternatively, the UI controller 231 downloads an application program for applying for the use of the MaaS service and the MaaS insurance from the server 11 and executes the application program. Accordingly, display of the user interface for applying for the use of the MaaS service and the MaaS insurance is started.

In step S2, the UI controller 231 determines whether or not to perform user registration. For example, in a case where the user has not yet performed the user registration for using the MaaS service, the user performs an operation for performing the user registration by using the operation unit 204. In a case where the operation for performing the user registration is performed, the UI controller 231 determines to perform the user registration, and the processing proceeds to step S3.

In step S3, the user terminal 15 requests user registration.

For example, the display 205 displays a user registration screen under the control of the UI controller 231.

In response to the above, the user inputs data necessary for user registration such as attribute data of the user by using the operation unit 204. For example, the user inputs the name, date of birth, sex, address, telephone number (fixed-line phone, mobile phone), e-mail address, and the like of the user. Furthermore, the user inputs, for example, authentication data (for example, a user ID, a password, fingerprint authentication data, iris authentication data, face authentication data, and the like) necessary for user authentication.

The UI controller 231 transmits the input data (hereinafter referred to as user registration data) to the server 11.

In response to the above, as described later, the server 11 performs user registration on the basis of the user registration data.

Thereafter, the processing proceeds to step S5.

On the other hand, in step S2, for example, in a case where the user has already performed user registration for using the MaaS service, the user performs an operation for applying for the MaaS service by using the operation unit 204. In a case where the operation for applying for the MaaS service is performed, the UI controller 231 determines not to perform user registration, and the processing proceeds to step S4.

In step S4, the user terminal 15 requests user authentication.

For example, the display 205 displays a user authentication screen under the control of the UI controller 231.

In response to the above, the user inputs the authentication data necessary for the user authentication by using the operation unit 204.

The UI controller 231 transmits the input authentication data to the server 11.

In response to the above, as described later, the server 11 performs the user authentication on the basis of the authentication data. In a case where the user authentication is successful, the processing is continued and proceeds to step S5. On the other hand, in a case where the user authentication fails, the processing ends.

In step S5, the user terminal 15 provides notification of desired conditions of the user. Specifically, the display 205 displays an input screen of desired conditions of the user for the MaaS service and the MaaS insurance under the control of the UI controller 231.

The desired conditions for the MaaS service include, for example, the schedule of the user and a budget and desired condition for the mobility means. The schedule of the user includes, for example, a departure place, a destination, a transit place, a departure time at which the user departs from the departure place, a time at which the user wishes to arrive at the destination (hereinafter referred to as target time), and a plan at the destination.

The plan at the destination includes, for example, presence or absence of a service to be used by the user at the destination, content, a timeline, a place, a fee of the service planned to be used, whether or not the service is reserved, whether or not to stay, whether or not an accommodation facility is reserved, details and a fee of the reserved accommodation facility, and the like.

The desired conditions for the mobility means include, for example, a budget, a mobility means desired to be used, a mobility means not desired to be used, whether or not a reserved seat is used, a grade of the mobility means to be used, and the like. In addition, the desired conditions for the mobility means include a desired condition related to the mobility means used at a time of rerouting.

The desired conditions for the MaaS insurance include, for example, a type, grade, and the like of the insurance. The type and grade of the insurance are determined by, for example, a coverage range, a compensation method, a rate of compensation for loss, and the like.

The UI controller 231 transmits data indicating the desired conditions input by the user to the server 11.

In response to the above, as described later, the server 11 creates a route proposal between the departure place and the destination and an insurance plan on the basis of the desired conditions of the user.

In step S6, the user terminal 15 presents the route proposal and the insurance plan. Specifically, the display 205 displays a screen indicating the route proposal and the insurance plan created by the server 11 under the control of the UI controller 231. As a result, the route proposal and the insurance plan are presented to the user.

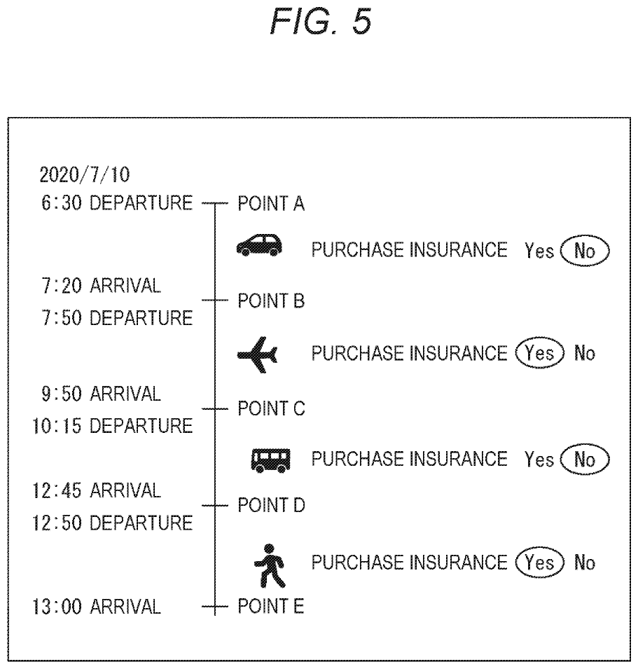

FIG. 5 shows an example of a screen displayed at this time. In this example, a route proposal from a point A as a departure place to a point E as a destination is displayed.

Specifically, transit places from the point A to the point E, an arrival time and a departure time of each transit place, and a type of a mobility means used in each section are illustrated. For example, a rental car is set as the mobility means in the section between the point A and the point B. An airplane is set as the mobility means in the section between the point B and the point C. A bus is set as the mobility means in the section between the point C and the point D. Walking is set as the mobility means in the section between the point D and the point E.

Furthermore, in this example, the user can select a section to which the MaaS insurance is applied from among the sections (mobility means) within the route. In other words, the user can select whether or not to purchase the MaaS insurance for every section (mobility means). For example, a loss caused by a mobility means in a section to which the insurance is applied (section for which the insurance is purchased) is not a compensation subject, and a loss caused by a mobility means in a section to which the insurance is not applied (section for which the insurance is not purchased) is not a compensation subject.

Note that the selection of whether or not to purchase the MaaS insurance for every section may be disabled, and the purchase of the MaaS insurance may be enabled only for the entire route.

Furthermore, for example, in the processing of steps S5 and S6, by changing the desired conditions, the user can change a proposed content of the route proposal and the insurance plan.

In step S7, the user terminal 15 transmits a selection result of the route and the insurance plan.

For example, the user selects a desired route (hereinafter referred to as a contract route) and an insurance plan from among suggested route proposals and insurance plans by using the operation unit 204.

The UI controller 231 transmits data indicating the selection result of the contract route and the insurance plan to the server 11.

In response to the above, as described later, the server 11 calculates an insurance premium to be paid by the user (policyholder) on the basis of the selected contract route and insurance plan.

In step S8, the user terminal 15 presents the insurance premium. Specifically, the display 205 displays a screen indicating the insurance premium calculated by the server 11 under the control of the UI controller 231. As a result, the insurance premium is presented to the user.

In step S9, the user terminal 15 applies for the use of the service.

Specifically, the user performs an operation necessary for applying for the use of the MaaS service and the MaaS insurance by using the operation unit 204. At this time, the user inputs data necessary for the use application by using the operation unit 204 as necessary. The data necessary for the use application is assumed to be, for example, the name of a policyholder who makes a contract for the MaaS insurance, the name of an insured person of the MaaS insurance, and data of a certificate for certifying the identity of the policyholder or the insured person (for example, scan data of a driver's license or the like). Furthermore, the policyholder and the insured person of the MaaS insurance may be the same or different.

The UI controller 231 transmits data related to the use application of the MaaS service and the MaaS insurance to the server 11.

In response to the above, as described later, the server 11 performs processing in response to the use application of the MaaS service and the MaaS insurance by using the data received from the user terminal 15.

Thereafter, the service use application processing ends.

Note that, for example, the user can stop the service use application at any timing during the processing of FIG. 4.

<Service Use Application Reception Processing>

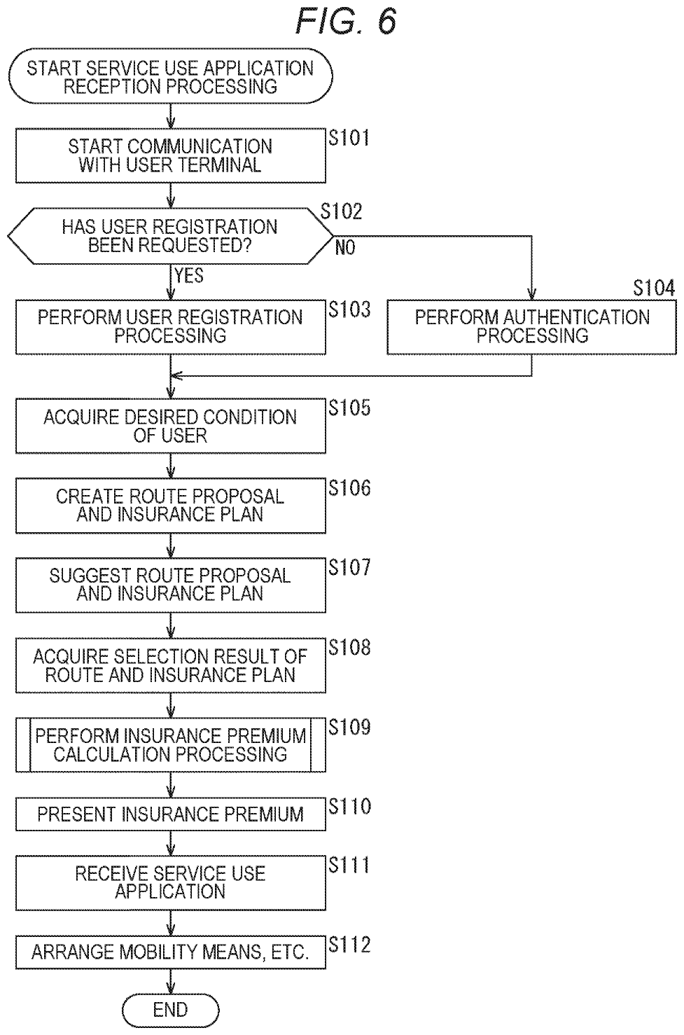

Next, service use application reception processing executed by the server 11 in response to the service use application processing of the user terminal 15 in FIG. 4 will be described with reference to a flowchart of FIG. 6.

In step S101, the server 11 starts communication with the user terminal 15. Specifically, in response to the processing of the user terminal 15 in step S1 of FIG. 4 described above, the communication unit 109 starts communication with the user terminal 15 via the network 21 under the control of the communication controller 138.

The terminal controller 137 controls the user terminal 15 to start processing of displaying a user interface for applying for the use of the MaaS service and the MaaS insurance.

Alternatively, the terminal controller 137 transmits an application program for applying for the use of the MaaS service and the MaaS insurance to the user terminal 15 and causes the user terminal 15 to execute the application program.

In step S102, the user registration processor 131 determines whether or not user registration has been requested. For example, in a case where an operation for performing user registration is performed in the user terminal 15 in the processing of step S2 in FIG. 4 described above, the user registration processor 131 determines that user registration has been requested, and the processing proceeds to step S103.

In step S103, the user registration processor 131 performs the user registration processing. Specifically, the user registration processor 131 receives the user registration data transmitted from the user terminal 15 in the processing of step S3 in FIG. 4 described above. The user registration processor 131 registers information regarding the user in the user DB 104 on the basis of the user registration data.

Thereafter, the processing proceeds to step S105.

On the other hand, in a case where it is determined in step S102 that user registration has not been requested, the processing proceeds to step S104.

In step S104, the use application processor 132 performs authentication processing. Specifically, the use application processor 132 receives the authentication data transmitted from the user terminal 15 in the processing of step S4 in FIG. 4 described above. The use application processor 132 collates the received authentication data with the authentication data of the user registered in the user DB 104, and in a case where the authentication data matches with the authentication data of the user registered in the user DB 104, the processing proceeds to step S105.

Note that, in a case where the authentication data do not match, the service use application reception processing ends.

In addition, a method of user authentication is not limited to the above-described method, and other methods can be adopted. For example, in a case where the user terminal 15 has a unique code, a code of the user terminal 15 may be registered in the user DB 104 at the time of user registration, and the user authentication may be performed without a password by using the code of the user terminal 15.

In step S105, the server 11 acquires the desired conditions of the user. Specifically, the terminal controller 137 controls the display of the input screen of the desired conditions of the user on the user terminal 15. In addition, the CPU 101 receives the data indicating the desired conditions of the user transmitted from the user terminal 15 in the processing of step S5 of FIG. 4 described above.

In step S106, the server 11 creates a route proposal and an insurance plan.

Specifically, the route setting unit 134 creates a plurality of route proposals combining one or more mobility means on the basis of the desired conditions of the user. For example, on the basis of information stored in the traffic information DB 12 and the route DB 105, the route setting unit 134 searches for a route within the designated budget from among routes that depart from the departure place at the departure time, pass through designated transit places, and arrive at the destination by the target time. The route setting unit 134 creates a plurality of route proposals on the basis of a search result.

At this time, for example, the route setting unit 134 searches for a route by raising a priority order of the mobility means desired by the user and lowering the priority order of the mobility means not desired by the user. Furthermore, for example, the route setting unit 134 adjusts a walking distance, a transfer time, and the like on the basis of the attribute of the user (for example, age, sex, and the like) and the like.

Note that, for example, the route setting unit 134 is not required to create a route that satisfies all the desired conditions, and may create a route plan excluding some of the desired conditions as necessary.

On the basis of the information stored in the insurance DB 106, the insurance designer 135 creates a MaaS insurance plan corresponding to each route plan on the basis of a combination of mobility means in each route plan, a moving distance and a moving time of each mobility means, and the like.

In step S107, the server 11 suggests the route proposal and the insurance plan. Specifically, the terminal controller 137 controls the user terminal 15 to display a screen for presenting the route proposal and the insurance plan.

In step S108, the server 11 acquires a selection result of the route and the insurance plan. Specifically, the CPU 101 receives the data indicating the selection result of the route and the insurance plan transmitted from the user terminal 15 in the processing of step S7 of FIG. 4 described above.

In step S109, the insurance designer 135 executes insurance premium calculation processing.

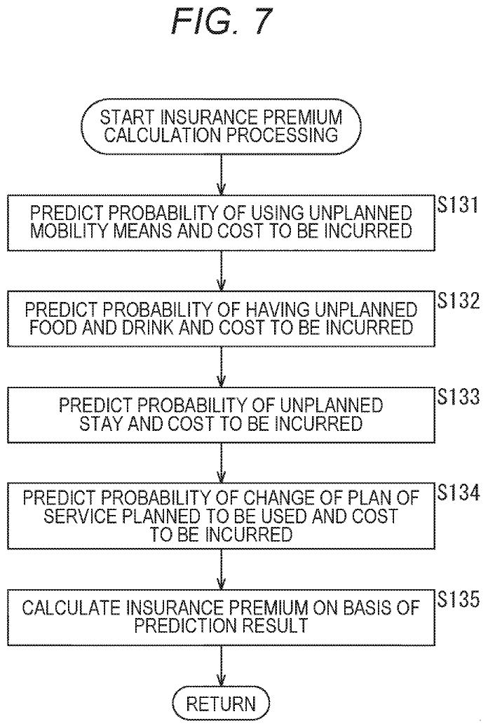

Here, details of the insurance premium calculation processing will be described with reference to a flowchart of FIG. 7.

In step S131, the insurance designer 135 predicts a probability of using an unplanned mobility means and a cost to be incurred on the basis of information or the like stored in the traffic information DB 12, the route DB 105, and the insurance DB 106.

For example, the insurance designer 135 predicts a probability of using another route (hereinafter referred to as an alternative route) and a content of the alternative route since the destination cannot be reached by the target time on the contract route on the basis of a delay occurrence rate, an accident occurrence rate, the expected value of the delay time, and the like of each mobility means within the contract route. The content of the alternative route includes, for example, a mobility means to be used, time to use each mobility means, time to arrive at the destination, and the like.

Furthermore, for example, the insurance designer 135 predicts the cost to be incurred by using the alternative route on the basis of a prediction result of the probability of using the alternative route and the content of the alternative route. As the cost to be incurred by using the alternative route, for example, a cancellation fee of the mobility means within the contract route, a fee of the mobility means (hereinafter referred to as alternative mobility means) within the alternative route, and the like are assumed.

In step S132, the insurance designer 135 predicts a probability of having unplanned food and drink and a cost to be incurred.

For example, in a case where a delay of arrival at the destination, an increase in waiting time, or the like occurs by rerouting, it is assumed that the user has unplanned food and drink. Therefore, the insurance designer 135 predicts a probability of having unplanned food and drink and a cost to be incurred by the unplanned food and drink on the basis of, for example, the prediction result of the probability of using the alternative route and the content of the alternative route, or the like.

In step S133, the insurance designer 135 predicts a probability of an unplanned stay and a cost to be incurred.

For example, in a case where arrival at the destination is delayed by rerouting, it is assumed that the user might unexpectedly stay at a place other than the destination. Therefore, for example, the insurance designer 135 predicts a probability of an unplanned stay and a cost to be incurred by the unplanned stay on the basis of the prediction result of the probability of using the alternative route and the content of the alternative route, or the like. As the cost to be incurred, for example, an accommodation fee for an unscheduled stay, a cancellation fee for an accommodation facility to be used, and the like are assumed.

In step S134, the insurance designer 135 predicts a probability of a change of plan of a service planned to be used and a cost to be incurred.

For example, in a case where arrival at the destination is delayed by rerouting, it is assumed that use time of the service planned to be used by the user might be changed or canceled. Furthermore, as described later, in a case where cancellation of a service planned to be used has occurred, the server 11 suggests a substitute service similar to the canceled service (hereinafter referred to as an alternative service) to the user.

On the other hand, for example, the insurance designer 135 predicts a probability of changing or canceling the use time of the service planned to be used, a probability of using the alternative service, and a cost incurred by the change of the plan of the service planned to be used on the basis of the probability of using the alternative route, the prediction result of the content of the alternative route, the information stored in the service DB 13, and the like. As the cost to be incurred, for example, a cost required for changing the use time of the service, a cancellation fee of the service, a fee for the alternative service, and the like are assumed.

In step S135, the insurance designer 135 calculates an insurance premium on the basis of the prediction result. For example, the insurance designer 135 calculates an expected value of the damage to the user caused by rerouting on the basis of the above-described various probabilities and predicted values of the costs to be incurred. Then, the insurance designer 135 calculates an insurance premium to be charged to the user on the basis of the content of the insurance plan selected by the user, whether or not the insurance is applied for every section (mobility means) within the contract route, the expected value of the damage caused by rerouting, and the like.

Thereafter, the insurance premium calculation processing ends.

In FIG. 6 again, in step S110, the server 11 presents the insurance premium. Specifically, the terminal controller 137 controls the user terminal 15 to display a screen for presenting the insurance premium.

In step S111, the server 11 receives a service use application. Specifically, in the processing of step S9 in FIG. 4 described above, the use application processor 132 receives the data related to the use application for the MaaS service and the MaaS insurance transmitted from the user terminal 15.

The use application processor 132 stores information indicating the contents of the MaaS service and the MaaS insurance with which the user has a contract, and the like in the user DB 104 on the basis of the received data. In addition, the use application processor 132 stores information indicating the schedule of the user included in the desired conditions of the user in the user DB 104 in association with the MaaS service with which the user has a contract.

In step S112, the route setting unit 134 arranges mobility means and the like. Specifically, the route setting unit 134 communicates with another server (not shown) about a mobility means that needs to be arranged in advance among the mobility means within the contract route, and performs processing of reserving the mobility means, purchasing a ticket, and the like.

Thereafter, the service use application reception processing ends.

<First Embodiment of Service Use Processing>

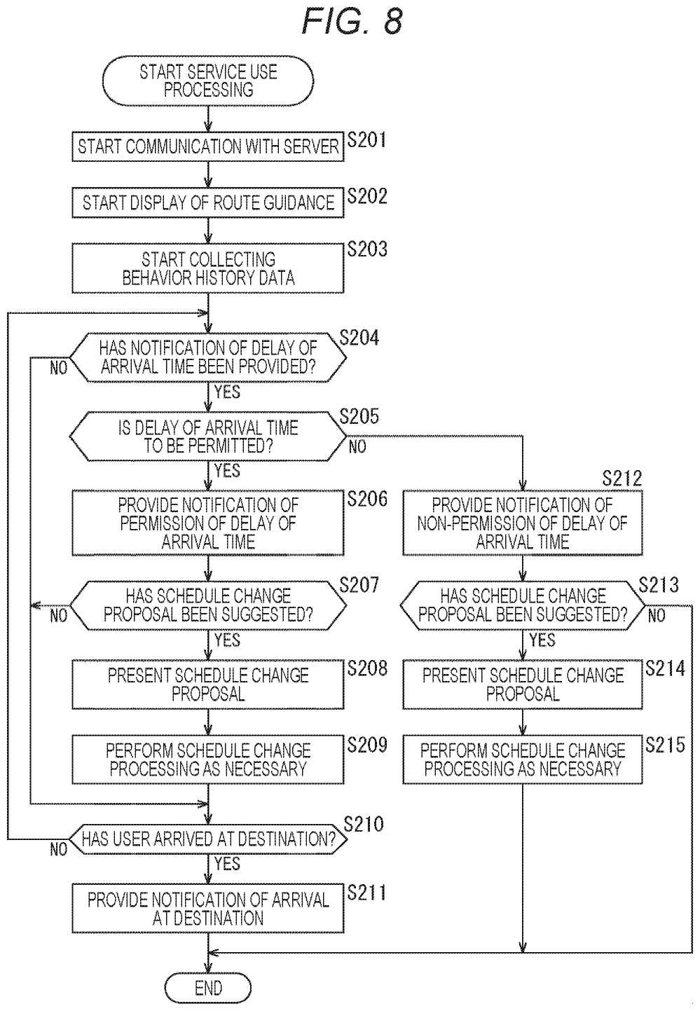

Next, a first embodiment of the service use processing executed by the user terminal 15 will be described with reference to a flowchart of FIG. 8.

This processing is started, for example, in a case where the user performs an operation for using the MaaS service by using the operation unit 204.

Note that, for example, in a case where the use of the service is immediately started after service application processing of FIG. 4, the service use processing is executed following the service application process of FIG. 4.

In step S201, the user terminal 15 starts communication with the server 11. Specifically, the communication unit 209 starts communication with the server 11 via the network 21 under the control of the communication controller 233.

The UI controller 231 starts processing of causing the display 205 to display a user interface for using the MaaS service on the basis of the data received by the communication with the server 11.

Alternatively, the UI controller 231 receives an application program for using the MaaS service from the server 11 and executes the application program. Accordingly, display of the user interface for using the MaaS service is started.

Then, the display 205 displays a user authentication screen under the control of the UI controller 231.

In response to the above, the user inputs the authentication data by using the operation unit 204.

The UI controller 231 transmits the authentication data to the server 11.

In response to the above, as described later, the server 11 performs the user authentication on the basis of the authentication data. In a case where the user authentication is successful, the processing is continued and proceeds to step S202. On the other hand, in a case where the user authentication fails, the processing ends.

In step S202, the display 205 starts display of a route guidance under the control of the UI controller 231. As a result, a guidance of the contract route is started.

In step S203, the data generator 232 starts collecting behavior history data.

Specifically, the data generator 232 starts processing of extracting data capable of tracking the behavior of the user who is using the MaaS service from data fed from the sensing unit 208 and the communication unit 209. For example, position information indicating a current position of the user (the user terminal 15), data indicating a history of getting on and off the mobility means and paying charges, data indicating a history of entering and exiting various facilities (for example, a ticket gate of a station, a gate of a building, and the like), data indicating a history of payment of food and drink and shopping in various stores, and the like are extracted.

In addition, the data generator 232 starts processing of storing the extracted data together with date and time information (time stamp) in the storage 203 as behavior history data.

At this time, for example, the data generator 232 encrypts the behavior history data so as not to be falsified. In addition, for example, the data generator 232 stores the behavior history data in association with the authentication data of the user so as to be proved that the collected behavior history data is of the user. This authentication data may be, for example, the authentication data acquired in the processing of step S201 described above, or may be newly acquired authentication data.

Furthermore, for example, the data generator 232 may continuously collect authentication data indicating a feature of the user and associate the authentication data with the behavior history data so as to prove more firmly that the collected behavior history data is of the user himself/herself. As such authentication data, for example, biometric information such as heartbeat data of the user, gait data indicating a feature of a way of walking of the user, and the like are assumed.

In step S204, the UI controller 231 determines whether or not notification of a delay of the arrival time has been provided.

For example, as described later, in a case where estimated arrival time at the destination is later than the target time due to a delay of the mobility means or the like, the server 11 notifies the user terminal 15 of the delay of the arrival time.

In response to the above, the UI controller 231 determines that the notification of the delay of the arrival time has been provided from the server 11, and the processing proceeds to step S205.

In step S205, the UI controller 231 determines whether or not to permit the delay of the arrival time.

Specifically, the display 205 provided the notification of the delay of the arrival time and displays a screen for selecting whether or not to permit the delay of the arrival time under the control of the UI controller 231.

In response to the above, the user selects whether or not to permit the delay of the arrival time by operating the operation unit 204.

Then, in a case where the UI controller 231 determines to permit the delay of the arrival time on the basis of the selection of the user, the processing proceeds to step S206.

In step S206, the UI controller 231 provides notification of permission of the delay of the arrival time. Specifically, the UI controller 231 transmits, to the server 11, data providing the notification of permission of the delay of the arrival time.

In step S207, the UI controller 231 determines whether or not a schedule change proposal has been suggested.

For example, as described later, in a case where it is necessary for the user to cancel a service or an accommodation facility planned to be used due to the delay of the arrival time to the destination, the server 11 searches for an alternative service or an alternative accommodation facility, and transmits data indicating a schedule change proposal including a search result to the user terminal 15. Furthermore, in a case where unplanned accommodation is required due to the delay of the arrival time at the destination, the server 11 searches for an accommodation facility and transmits data indicating a schedule change proposal including the search result to the user terminal 15.

In response to the above, in a case where the UI controller 231 receives the data indicating the schedule change proposal from the server 11, the UI controller 231 determines that the schedule change proposal has been suggested, and the processing proceeds to step S208.

In step S208, the user terminal 15 presents the schedule change proposal. Specifically, the display 205 displays a screen indicating the schedule change proposal under the control of the UI controller 231. As a result, the schedule change proposal is presented to the user.

In step S209, the user terminal 15 performs schedule change processing as necessary.

For example, in a case where the user arranges the presented service or accommodation facility, the user performs an operation for making a reservation by using the operation unit 204.

In response to the above, the UI controller 231 communicates with a server (not shown), and performs processing of reserving and purchasing a ticket of the presented service or accommodation facility, and the like.

Thereafter, the processing proceeds to step S210.

On the other hand, in a case where it is determined in step S207 that a schedule change proposal has not been proposed, the processing in steps S208 and S209 is skipped, and the processing proceeds to step S210.

Furthermore, in a case where it is determined in step S204 that the notification of the delay of the arrival time has not been provided, the processing of steps S205 to S209 is skipped, and the processing proceeds to step S210.

In step S210, the UI controller 231 determines whether or not the user has arrived at the destination on the basis of the position information indicating the current position fed from the sensing unit 208. In a case where it is determined that the user has not arrived at the destination, the processing returns to step S204.

Thereafter, the processing of steps S204 to S210 is repeatedly executed until it is determined in step S210 that the user has arrived at the destination or it is determined not to permit the delay of the arrival time in step S205.

On the other hand, in a case where it is determined in step S210 that the user has arrived at the destination, the processing proceeds to step S211.

In step S211, the UI controller 231 provides notification of arrival at the destination. Specifically, the UI controller 231 transmits, to the server 11, data providing the notification that the user has arrived at the destination.

Thereafter, the service use processing ends.

On the other hand, in step S205, in a case where the UI controller 231 determines not to permit the delay of the arrival time on the basis of the selection of the user, the processing proceeds to step S212.

In step S212, the UI controller 231 provides notification of non-permission of the delay of the arrival time.

Specifically, the UI controller 231 transmits, to the server 11, data providing the notification of non-permission of the delay of the arrival time.

Thereafter, in steps S213 to S215, processing similar to the processing in steps S207 to S209 described above is executed, and then the service use processing ends.

<First Embodiment of Service Providing Processing>

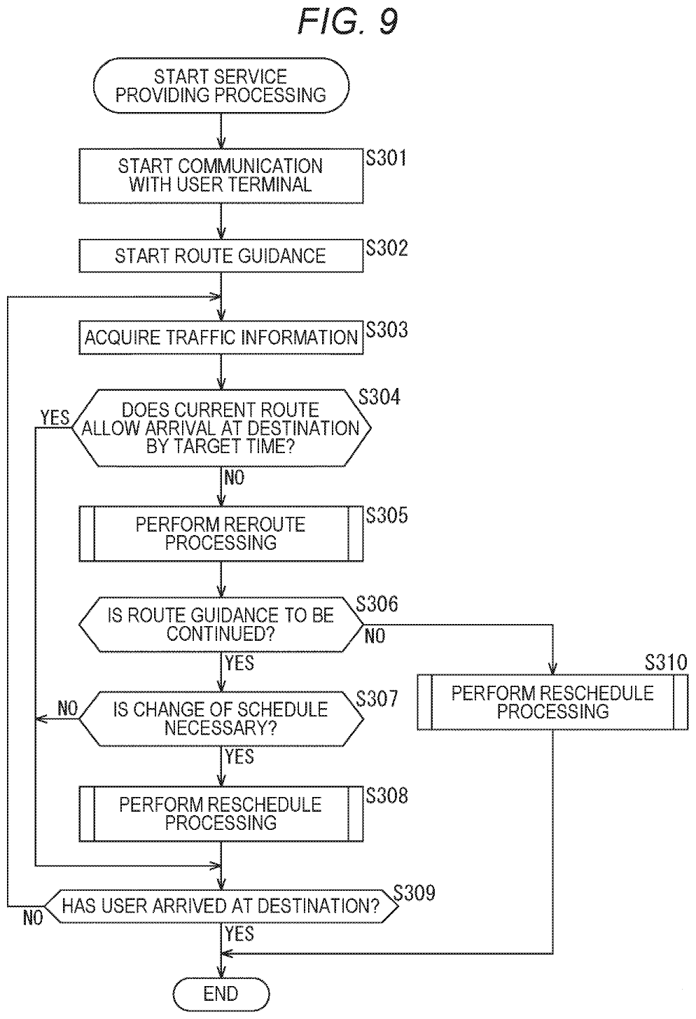

Next, a first embodiment of service providing processing executed by the server 11 in response to the service use processing by the user terminal 15 in FIG. 8 will be described with reference to a flowchart of FIG. 9.

In step S301, the server 11 starts communication with the user terminal 15. Specifically, in response to the processing of the user terminal 15 in step S201 of FIG. 8 described above, the communication unit 109 starts communication with the user terminal 15 via the network 21 under the control of the communication controller 233.

The terminal controller 137 controls the user terminal 15 to start processing of displaying a user interface for using the MaaS service.

Alternatively, the terminal controller 137 transmits an application program for using the MaaS service to the user terminal 15 and causes the user terminal 15 to execute the application program.

Furthermore, the terminal controller 137 receives the authentication data transmitted from the user terminal 15. The terminal controller 137 collates the received authentication data with the authentication data of the user registered in the user DB 104, and in a case where the authentication data matches with the authentication data of the user registered in the user DB 104, the processing proceeds to step S302.

Note that, in a case where the authentication data do not match, service use providing processing ends.

In step S302, the server 11 starts a route guidance. Specifically, the terminal controller 137 reads, from the user DB 104, information regarding a contract route in the MaaS service with which the user has a contract. The terminal controller 137 starts processing of controlling the user terminal 15 to display a user interface for guiding the user to the contract route on the basis of the acquired information. Furthermore, the terminal controller 137 starts processing of recording a history of the route guided to the user in the user DB 104.

In step S303, the route setting unit 134 receives traffic information from the traffic information DB 12. This traffic information includes, for example, information regarding the operation status of each mobility means within the contract route and a status of roads through which the user passes on the contract route.

In step S304, the route setting unit 134 determines whether or not a current route allows arrival at the destination by the target time. Specifically, the route setting unit 134 predicts an estimated arrival time at the destination on the current route on the basis of the acquired traffic information. In a case where the predicted estimated arrival time is later than the target time, the route setting unit 134 determines that the current route does not allow arrival at the destination by the target time, and the processing proceeds to step S305.

In step S305, the route setting unit 134 executes reroute processing.

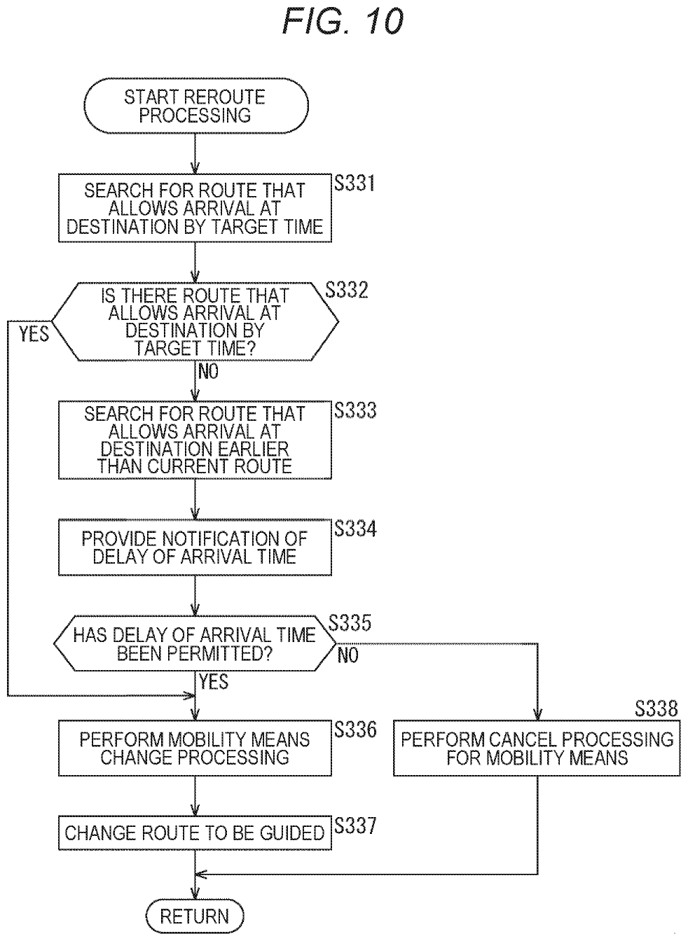

Here, details of the reroute processing will be described with reference to a flowchart of FIG. 10.

In step S331, the route setting unit 134 searches for a route that allows arrival at the destination by the target time on the basis of information and the like stored in the traffic information DB 12 and the route DB 105.

In step S332, the route setting unit 134 determines whether or not there is a route that allows arrival at the destination by the target time on the basis of a result of the processing in step S331. In a case where it is determined that there is no route that allows arrival at the destination by the target time, the processing proceeds to step S333.

In step S333, the route setting unit 134 searches for a route that allows arrival at the destination earlier than the current route on the basis of the information and the like stored in the traffic information DB 12 and the route DB 105.

In step S334, the terminal controller 137 provides notification of the delay of the arrival time.

Specifically, in a case where there is a route that allows arrival at the destination earlier than the current route, the terminal controller 137 controls the user terminal 15 to display a screen for providing notification that the arrival time is delayed together with the route and the estimated arrival time.

On the other hand, in a case where there is not a route that allows arrival at the destination earlier than the current route, the terminal controller 137 controls the user terminal 15 to display a screen for providing the notification that the arrival time will be delayed together with the estimated arrival time of the current route.

In step S335, the terminal controller 137 determines whether or not a delay of the arrival time has been permitted. In a case where the terminal controller 137 receives data indicating permission for the delay of the arrival time transmitted from the user terminal 15 in step S206 of FIG. 8 described above, the terminal controller 137 determines that the delay of the arrival time has been permitted, and the processing proceeds to step S336.

On the other hand, in a case where it is determined in step S332 that there is a route that allows arrival at the destination by the target time, the processing of steps S333 to S335 is skipped, and the processing proceeds to step S336.

In step S336, the route setting unit 134 performs mobility means change processing.

For example, in a case where there is a plurality of routes that allows arrival at the destination by the target time, the route setting unit 134 selects an alternative route from the plurality of routes on the basis of a predetermined condition. For example, a route closest to the desired conditions of the user, a route with the lowest cost, or the like is selected as the alternative route. Alternatively, for example, candidates for the alternative route may be presented to the user, and the user may select a candidate.

On the other hand, in a case where there is no route that allows arrival at the destination by the target time, the route setting unit 134 selects an alternative route from among routes that allows arrival at the destination earlier than the current route on the basis of a predetermined condition. For example, a route that allows arrival at the destination earliest, a route closest to the desired conditions of the user, a route with the lowest cost, or the like is selected as the alternative route. Alternatively, for example, candidates for the alternative route may be presented to the user, and the user may select a candidate. In addition, the route setting unit 134 updates the target time to an estimated arrival time at a target point of the alternative route.

Furthermore, in a case where there is no route that allows arrival at the destination earlier than the current route, the route setting unit 134 sets a route in which the target time or the like of the current route is changed as the alternative route.

Then, for example, the route setting unit 134 communicates with another server (not shown) about a mobility means that needs to be arranged in advance among the mobility means within the alternative route, and performs processing of reserving the mobility means, purchasing a ticket, and the like. In addition, the route setting unit 134 communicates with another server (not shown) for a mobility means that needs to be canceled among the mobility means within the route before the change, and performs cancel processing for the mobility means.

In step S337, the terminal controller 137 changes the route to be guided. That is, the terminal controller 137 sets the route to be guided to the user as the alternative route.

Thereafter, the reroute processing ends.

On the other hand, in step S335, in a case where the terminal controller 137 receives data indicating non-permission for the delay of the arrival time transmitted from the user terminal 15 in step S212 of FIG. 8 described above, the terminal controller 137 determines that the delay of the arrival time has not been permitted, and the processing proceeds to step S338.

In step S338, the route setting unit 134 performs cancel processing for the mobility means. Specifically, the route setting unit 134 communicates with another server (not shown) for a mobility means that needs to be canceled among the mobility means within the current route, and performs cancel processing for the mobility means.

Thereafter, the reroute processing ends.

In FIG. 9 again, in step S306, the terminal controller 137 determines whether or not to continue the route guidance. For example, in a case where the delay of the arrival time has been permitted by the user, the terminal controller 137 determines to continue the route guidance, and the processing proceeds to step S307.

In step S307, the schedule setting unit 133 determines whether or not a change of the schedule is necessary. Specifically, in a case where a current schedule of the user cannot be executed as planned by rerouting, the schedule setting unit 133 determines that the change of the schedule is necessary, and the processing proceeds to step S308.

In step S308, the schedule setting unit 133 executes reschedule processing, and thereafter, the processing proceeds to step S309.

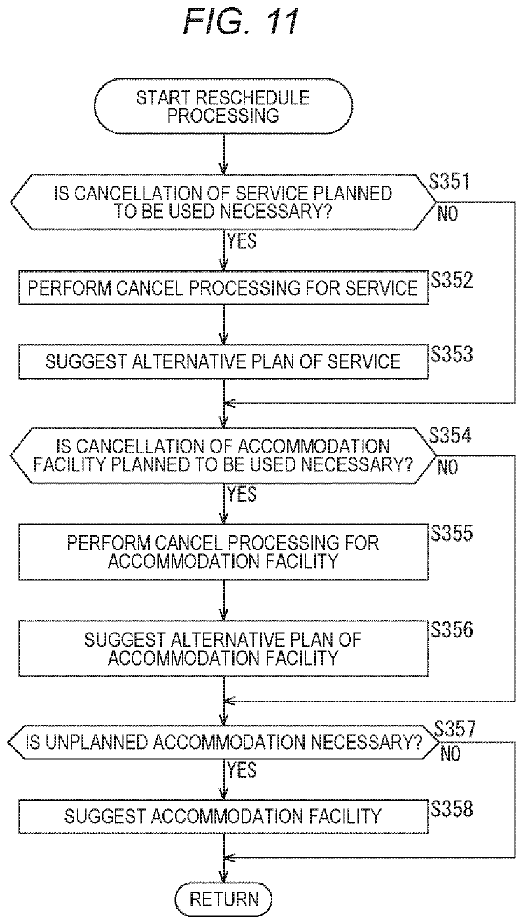

Here, details of the reschedule processing will be described with reference to a flowchart of FIG. 11.

In step S351, the schedule setting unit 133 determines whether or not cancellation of the service planned to be used is necessary on the basis of the alternative route. In a case where it is determined that cancellation of the service planned to be used is necessary, the processing proceeds to step S352.

Note that, as a case where cancellation of the service planned to be used is necessary, for example, the following cases are assumed.
The user will not be in time for a start time of a reserved event, tour, or the like.
The user will not be in time for a reservation time of a reserved restaurant, medical institution, or the like.

In step S352, the schedule setting unit 133 performs cancel processing for the service. Specifically, the schedule setting unit 133 accesses a server (not shown) and performs cancel processing for the service determined to need to be canceled in the processing of step S351.

Note that, at this time, the schedule setting unit 133 may confirm with the user whether or not the service planned to be used may be canceled, and perform the cancel processing only in a case where the user approves.

In step S353, the server 11 suggests an alternative plan of the service.

For example, the schedule setting unit 133 searches for an alternative service similar to the canceled service and available after the user arrives at the destination from the information stored in the service DB 13.

For example, in a case where an event, a tour, or the like is canceled, the schedule setting unit 133 searches for an event, a tour, or the like whose start time the user will be in time for among events, tours, or the like having similar contents.

For example, in a case where a reservation of a restaurant, a medical institution, or the like is canceled, the schedule setting unit 133 searches for another time zone that the user can be reserve and arrive at, of the same restaurant, the medical institution, or the like, or the same type of restaurant, the medical institution, or the like.

The terminal controller 137 controls the user terminal 15 to display a screen for presenting a schedule change proposal including a search result of the alternative service.

Thereafter, the processing proceeds to step S354.

On the other hand, in a case where it is determined in step S351 that cancellation of the service planned to be used is unnecessary, the processing in steps S352 and S353 is skipped, and the processing proceeds to step S354.

In step S354, the schedule setting unit 133 determines whether or not cancellation of the accommodation facility planned to be used is necessary on the basis of the alternative route. For example, in a case where the user cannot arrive at the destination by a final check-in time of the accommodation facility planned to be used, the schedule setting unit 133 determines that cancellation of the accommodation facility planned to be used is necessary, and the processing proceeds to step S355.

In step S355, the schedule setting unit 133 performs cancel processing for the accommodation facility. Specifically, the schedule setting unit 133 accesses a server (not shown) and performs cancel processing for the accommodation facility determined to need to be canceled in the processing of step S354.

In step S354, the server 11 suggests an alternative plan of the accommodation facility.

For example, the schedule setting unit 133 searches for an alternative accommodation facility that can be reserved among accommodation facilities at a similar level to the canceled accommodation facility at a location where the user can arrive during that day from the information stored in the accommodation facility DB 14.

The terminal controller 137 controls the user terminal 15 to display a screen for presenting a schedule change proposal including a search result of the alternative accommodation facility.

Thereafter, the processing proceeds to step S357.

On the other hand, in step S354, in a case where the user can arrive at the destination by the final check-in time of the accommodation facility planned to be used, the schedule setting unit 133 determines that cancellation of the accommodation facility planned to be used is unnecessary, the processing of steps S355 and S356 is skipped, and the processing proceeds to step S357.

In step S357, the schedule setting unit 133 determines whether or not unplanned accommodation is necessary. For example, in a case where the schedule setting unit 133 determines that unplanned accommodation is necessary because the user cannot arrive at the destination (for example, home) on that day, or for other reasons, the processing proceeds to step S358.

In step S358, the server 11 suggests an accommodation facility.

For example, the schedule setting unit 133 searches for an accommodation facility that can be reserved at a location where the user can arrive on that day from the information stored in the accommodation facility DB 14.

The terminal controller 137 controls the user terminal 15 to display a screen for presenting a schedule change proposal including a search result of the accommodation facility.

Note that, even in a case where there is unplanned accommodation the MaaS service is continuously provided to the user, for example, after the next day until the user arrives at the destination.

Thereafter, the reschedule processing ends.

On the other hand, in a case where it is determined in step S357 that unplanned accommodation is unnecessary, the processing of step S358 is skipped, and the reschedule processing ends.

In FIG. 9 again, on the other hand, in a case where it is determined in step S307 that the change of the schedule is unnecessary, the processing of step S308 is skipped, and the processing proceeds to step S309.

Furthermore, in step S304, in a case where the predicted estimated arrival time is before the target time, the route setting unit 134 determines that the current route allows arrival at the destination by the target time, the processing of steps S305 to S308 is skipped, and the processing proceeds to step S309.

In step S309, the route setting unit 134 determines whether or not the user has arrived at the destination. In a case where the route setting unit 134 has not been received data providing notification that the user has arrived at the destination from the user terminal 15, the route setting unit 134 determines that the user has not arrived at the destination yet, and the processing returns to step S303.

Thereafter, the processing of steps S304 to S309 is repeatedly executed until it is determined in step S309 that the user has arrived at the destination or it is determined in step S306 not to continue the route guidance.

On the other hand, in step S309, in a case where the route setting unit 134 receives the data providing the notification that the user has arrived at the destination transmitted from the user terminal 15 in the processing of step S211 in FIG. 8 described above, the route setting unit 134 determines that the user has arrived at the destination, and the service providing processing ends.

Furthermore, in step S306, for example, in a case where the delay of the arrival time has not been permitted by the user, the terminal controller 137 determines not to continue the route guidance, and the processing proceeds to step S310.

In step S310, as in a similar manner to step S308, after the reschedule processing is executed, the service providing processing ends.

<Specific Examples of Reroute Processing>

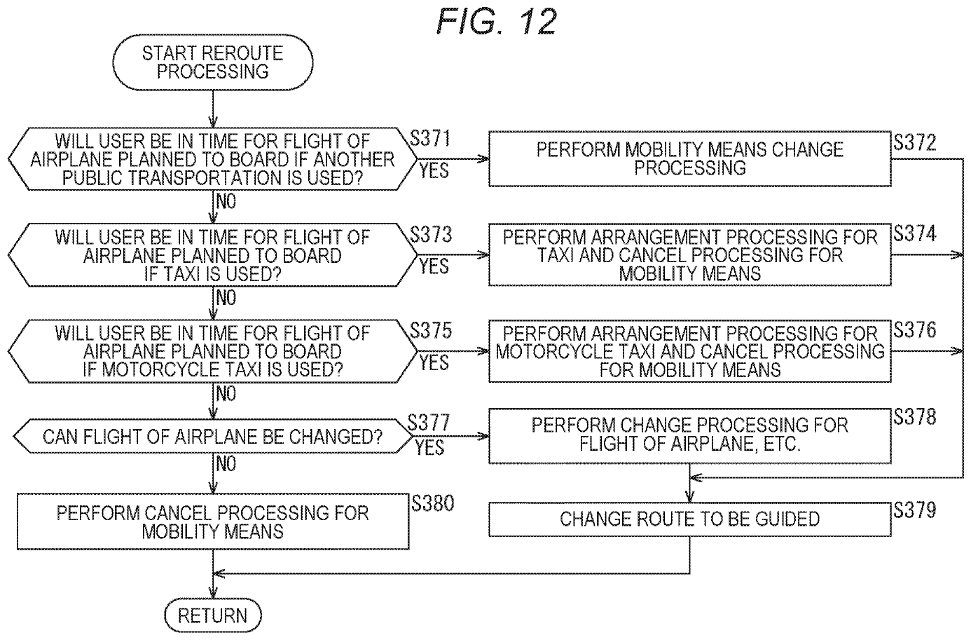

Next, specific examples of the reroute processing will be described with reference to a flowchart of FIG. 12.

Note that, in this processing, it is assumed that a contract route for heading to an airport by using public transportation such as a train and then heading to a destination by an airplane is set.

In step S371, the route setting unit 134 determines whether or not the user will be in time for a flight of the airplane planned to board if another public transportation is used on the basis of the information and the like stored in the traffic information DB 12 and the route DB 105. In a case where it is determined that the user will be in time for the flight of the airplane planned to board if another public transportation is used, the processing proceeds to step S372.

In step S372, the mobility means change processing is performed similarly to the processing of step S336 in FIG. 10.

Thereafter, the processing proceeds to step S379.

On the other hand, in a case where it is determined in step S371 that the user will not be in time for the flight of the airplane planned to board even if another transportation is used, the processing proceeds to step S373.

In step S373, the route setting unit 134 determines whether or not the user will be in time for the flight of the airplane planned to board if a taxi is used on the basis of the information and the like stored in the traffic information DB 12 and the route DB 105. In a case where it is determined that the user will be in time for the flight of the airplane planned to board if a taxi is used, the processing proceeds to step S374.

In step S374, the route setting unit 134 performs arrangement processing for a taxi and cancel processing for a mobility means. For example, the route setting unit 134 communicates with a server (not shown), and performs arrangement processing for a taxi and cancel processing for a mobility means planned to be used to the airport.

Thereafter, the processing proceeds to step S379.

On the other hand, in a case where it is determined in step S373 that the user will not be in time for the flight of the airplane planned to board even if a taxi is used, the processing proceeds to step S375.

In step S375, the route setting unit 134 determines whether or not the user will be in time for the flight of the airplane planned to board if a motorcycle taxi is used on the basis of the information and the like stored in the traffic information DB 12 and the route DB 105. In a case where it is determined that the user will be in time for the flight of the airplane planned to board if a motorcycle taxi faster than a taxi is used, the processing proceeds to step S376.

In step S376, the route setting unit 134 performs arrangement processing for a motorcycle taxi and cancel processing for a mobility means. For example, the route setting unit 134 communicates with a server (not shown), and performs arrangement processing for a motorcycle taxi and cancel processing for a mobility means planned to be used to the airport.

Thereafter, the processing proceeds to step S379.

On the other hand, in a case where it is determined in step S375 that the user will not be in time for the flight of the airplane planned to board even if a motorcycle taxi is used, the processing proceeds to step S377.

In step S377, the route setting unit 134 determines whether or not the flight of the airplane can be changed on the basis of the information and the like stored in the traffic information DB 12 and the route DB 105. For example, the route setting unit 134 determines that the flight of the airplane can be changed in a case where the reservation can be changed to a flight of an airplane that can depart at a time that allows the user to board the airplane and arrive at the destination at an allowable time for the user, and the processing proceeds to step S378.

In step S378, the route setting unit 134 performs change processing for the flight of the airplane and the like. For example, the route setting unit 134 communicates with a server (not shown) and performs processing of changing the reservation of the flight of the airplane for the user to board. Furthermore, in a case where the mobility means to the airport is changed, the route setting unit 134 performs cancel processing for the mobility means planned to be used and arrangement processing for the mobility means after the change.

Thereafter, the processing proceeds to step S379.

In step S379, the route to be guided is changed similarly to the processing of step S338 in FIG. 10.

Thereafter, the reroute processing ends.

On the other hand, in step S377, for example, the route setting unit 134 determines that the flight of the airplane cannot be changed in a case where the reservation cannot be changed to a flight of an airplane that can depart at a time that allows the user to board the airplane and arrive at the destination at an allowable time for the user, and the processing proceeds to step S380.

In step S380, the cancel processing for the mobility means is performed similarly to the processing of step S338 in FIG. 10. As a result, the mobility means to the airport and the reservation of the flight of the airplane planned for the user to board are canceled.

Thereafter, the reroute processing ends.

<Insurance Claim Processing>

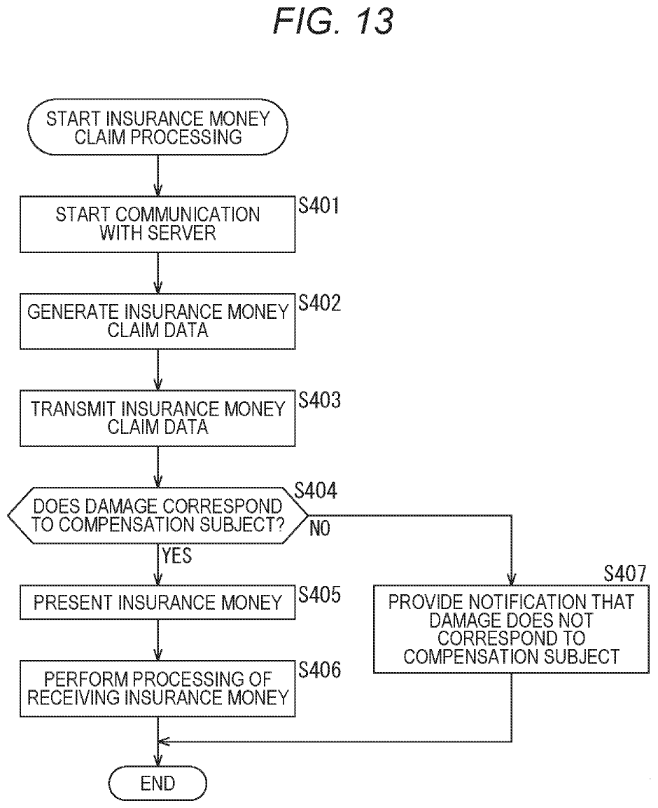

Next, insurance money claim processing executed by the user terminal 15 will be described with reference to a flowchart of FIG. 13.

This processing is started, for example, in a case where the user performs an operation for claiming insurance money by using the operation unit 204.

In step S401, communication with the server 11 is started similarly to the processing of step S201 in FIG. 8 described above. As a result, processing of displaying a user interface for performing an insurance money claim procedure on the display 205 is started.

In step S402, the data generator 232 generates the insurance money claim data.

Specifically, the display 205 displays a screen for inputting data necessary for claiming the insurance money under the control of the UI controller 231.

In response to the above, the user inputs the data necessary for claiming the insurance money by using the operation unit 204. For example, the user inputs data (hereinafter referred to as unplanned cost data) such as a receipt for proving an unplanned cost incurred by rerouting. As the unplanned cost, for example, a cost using an unplanned mobility means, a cost required for unplanned food and drink, a cost using an alternative service, a cost using an unplanned accommodation facility, and the like are assumed.

Furthermore, for example, in a case where a boarding time and the like are not strictly determined on the contract route and the alternative route guided from the server 11, and there is a section left to a discretion of the user, the user inputs data (hereinafter referred to as mobility means report data) indicating details of the mobility means used in the section.

The data generator 232 reads the behavior history data stored in the storage 203, and generates insurance money claim data including the behavior history data, the unplanned cost data, and the mobility means report data.

In step S403, the data generator 232 transmits the insurance money claim data to the server 11.

On the other hand, as described later, the server 11 determines whether or not the damage caused by rerouting corresponds to the compensation subject on the basis of the insurance money claim data, and transmits data for providing notification of a determination result to the user terminal 15.

In step S404, the UI controller 231 determines whether or not the damage corresponds to the compensation subject. Specifically, the UI controller 231 receives, from the server 11, data indicating whether or not the damage corresponds to the compensation subject. In a case where the UI controller 231 determines that the damage corresponds to the compensation subject on the basis of the received data, the processing proceeds to step S405.

In step S405, the user terminal 15 presents insurance money.

Specifically, in a case where it is determined that the damage caused by rerouting corresponds to the compensation subject, the server 11 calculates insurance money and controls the user terminal 15 to display a screen presenting the calculated insurance money.

In response to the above, the display 205 displays a screen presenting the insurance money under the control of the UI controller 231.

In step S406, the user terminal 15 performs processing of receiving the insurance money. For example, the display 205 displays a screen for performing the processing of receiving the insurance money under the control of the UI controller 231.

In response to the above, the user inputs various data for receiving the insurance money by using the operation unit 204.

The UI controller 231 transmits the data input by the user to the server 11.

Thereafter, the insurance money claim processing ends.

On the other hand, in a case where it is determined in step S404 that the damage does not correspond to the compensation subject, the processing proceeds to step S407.

In step S407, the user terminal 15 provides notification that the damage does not correspond to the compensation subject. Specifically, the display 205 displays a screen providing notification that the damage does not correspond to the compensation subject under the control of the UI controller 231.

Thereafter, the insurance money claim processing ends.

<Insurance Money Claim Response Processing>

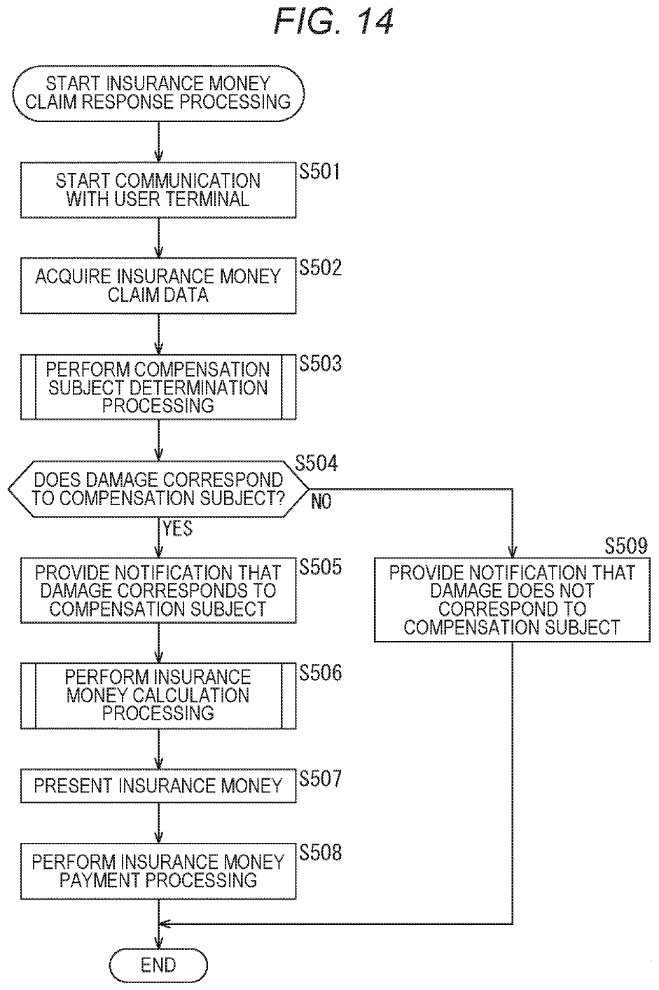

Next, insurance money claim response processing executed by the server 11 in response to the insurance money claim processing executed by the user terminal 15 in FIG. 13 will be described with reference to the flowchart of FIG. 14.

In step S501, communication with the user terminal 15 is started similarly to the processing in step S301 in FIG. 9 described above. As a result, processing of controlling the user terminal 15 to display a user interface for performing the insurance money claim procedure is started.

In step S502, the insurance money calculator 136 acquires the insurance money claim data. Specifically, the insurance money calculator 136 receives the insurance claim data transmitted from the user terminal 15 in the processing of step S403 in FIG. 13 described above.

In step S503, the insurance money calculator 136 executes compensation subject determination processing.

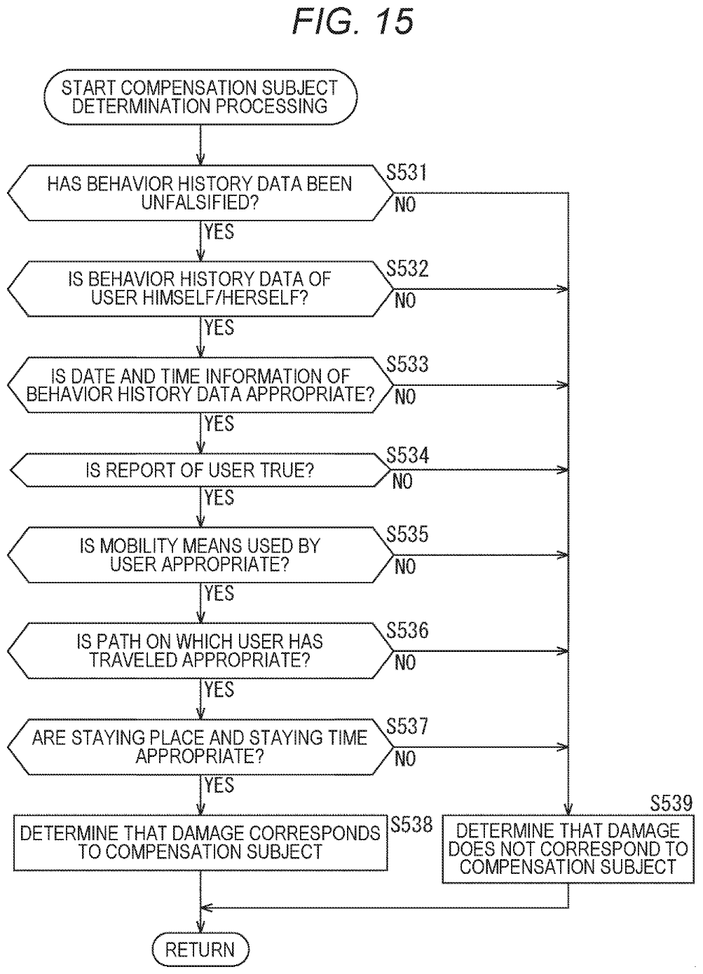

Here, details of the compensation subject determination processing will be described with reference to a flowchart of FIG. 15.

In step S531, the insurance money calculator 136 determines whether or not the behavior history data has been falsified. Specifically, the insurance money calculator 136 verifies the behavior history data using falsification detection data added to the behavior history data included in the insurance money claim data. For a falsification detection, for example, a message authentication code (MAC), a digital signature, or the like is used. Alternatively, for example, when the encrypted data is decrypted and is restored to a correct plaintext, it is verified that the encrypted data is not falsified. In a case where the insurance money calculator 136 determines that the behavior history data has not been falsified with as a result of a verification, the processing proceeds to step S532.

In step S532, the insurance money calculator 136 determines whether or not the behavior history data is of the user himself/herself on the basis of the authentication data included in the behavior history data. In some cases, the authentication data includes, for example, a success-failure result when the user terminal 15 authenticates the user, or in other cases, includes identification information of the user extracted from the behavior history data itself. In a case where it is determined that the behavior history data is of the user himself/herself, the processing proceeds to step S533.

In step S533, the insurance money calculator 136 determines whether or not the date and time information of the behavior history data is appropriate. In a case where the date and time information of the behavior history data matches a date and time when the user uses the MaaS service, the insurance money calculator 136 determines that the date and time information of the behavior history data is appropriate, and the processing proceeds to step S534.

In step S534, the insurance money calculator 136 determines whether or not a report of the user is false. Specifically, the insurance money calculator 136 estimates the mobility means actually used by the user and required time on the basis of the behavior history data. For example, the insurance money calculator 136 compares the mobility means indicated by the mobility means report data included in the insurance money claim data with the mobility means actually used by the user. In a case where the two coincide with each other, the insurance money calculator 136 determines that the report of the user is not false, and the processing proceeds to step S535.

In step S535, the insurance money calculator 136 determines whether or not the mobility means used by the user is appropriate.

For example, the insurance money calculator 136 compares the mobility means guided by the server 11 in accordance with the contract route or the alternative route with the mobility means actually used by the user.

Furthermore, for example, the insurance money calculator 136 estimates required time of each mobility means on the basis of the traffic information of that day stored in the traffic information DB 12. For example, the required time is estimated on the basis of delay information of public transportation, congestion information of roads, and the like. Then, the insurance money calculator 136 compares an estimated value of the required time of each mobility means with the actual required time (including the time reported by the user).

Then, in a case where the guided mobility means matches the mobility means actually used by the user, and a difference between the estimated value of the required time of each mobility means and the actual required time is less than a predetermined threshold value, the insurance money calculator 136 determines that the mobility means used by the user is appropriate, and the processing proceeds to step S536.

In step S536, the insurance money calculator 136 determines whether or not a path on which the user has traveled is appropriate. Specifically, the insurance money calculator 136 detects a path on which the user has traveled in a section where the user has used a mobility means other than a mobility means with a determined route, such as public transportation, on the basis of the behavior history data.

Then, in the section, the insurance money calculator 136 compares the route guided by the server 11 with the path on which the user has actually traveled. In a case where a difference between the guided route and the path on which the user has traveled is less than a predetermined threshold value and a difference between a traveling direction indicated by the guided route and a direction in which the user has actually traveled is less than a predetermined threshold value, the insurance money calculator 136 determines that the path on which the user has traveled is appropriate, and the processing proceeds to step S537.

In step S537, the insurance money calculator 136 determines whether or not a staying place and a staying time are appropriate. Specifically, the insurance money calculator 136 detects a place (staying place) and a time (staying time) where the user has stayed for a predetermined time or more while traveling on the basis of the behavior history data. Then, in a case where the insurance money calculator 136 determines that the detected staying place and staying time are appropriate, the processing proceeds to step S538.

In step S538, the insurance money calculator 136 determines that the damage corresponds to the compensation subject, and the compensation subject determination processing ends.

On the other hand, in step S537, in a case where the insurance money calculator 136 determines that at least one of the detected staying place or staying time is not appropriate, the processing proceeds to step S539. For example, in a case where the user stays at an inappropriate staying place, in a case where the staying time is not appropriate, or the like, it is determined that at least one of the detected staying place or staying time is not appropriate.

As a result, for example, it is possible to prevent a fraudulent act of illegally delaying the arrival time and acquiring insurance money due to an action in which the user repeatedly rests or stops, stays at one place for a long time, or the like (delaying tactics).

Furthermore, in step S536, in a case where the difference between the guided route and the path on which the user has traveled is greater than or equal to a predetermined threshold value and the difference between a traveling direction indicated by the guided route and the direction in which the user has actually traveled is greater than or equal to a predetermined threshold value, the insurance money calculator 136 determines that the path on which the user has traveled is inappropriate, and the processing proceeds to step S539.

As a result, for example, a fraudulent act of illegally delaying the arrival time and acquiring insurance money by an act of the user, such as intentionally making a detour, wrong-way-driving, or intentionally traveling in a congested section (deviation), is prevented.

Furthermore, in step S535, in a case where the guided mobility means does not match the mobility means actually used by the user, or the difference between the estimated value of the required time of each mobility means and the actual required time is greater than or equal to a predetermined threshold value, the insurance money calculator 136 determines that the mobility means used by the user is inappropriate, and the processing proceeds to step S539.

As a result, it is possible to prevent a fraudulent act of illegally delaying the arrival time and acquiring insurance money by an act of the user killing time (deviation, delaying tactics), such as using a mobility means different from the guided mobility means or intentionally traveling slowly by a mobility means such as a private car or walking.

Furthermore, in step S534, in a case where the mobility means indicated by the mobility means report data included in the insurance money claim data does not match the mobility means actually used by the user, the insurance money calculator 136 determines that the report by the user is false, and the processing proceeds to step S539.

As a result, a fraudulent act of illegally acquiring insurance money by reporting a false mobility means is prevented.

Furthermore, in step S533, in a case where the date and time information of the behavior history data does not match the date and time when the user uses the MaaS service, the insurance money calculator 136 determines that the date and time information of the behavior history data is inappropriate, and the processing proceeds to step S539.

In addition, in step S532, in a case where it is determined that the behavior history data is not of the user himself/herself, the processing proceeds to step S539.

Furthermore, in step S531, in a case where it is determined that the behavior history data has been falsified, the processing proceeds to step S539.

That is, in the processing of steps S531 to S533, reliability of the behavior history data is verified, and in a case where the reliability is low, it is determined that the damage does not correspond to the compensation subject. As a result, for example, a fraudulent act of acquiring insurance money by using fraudulent behavior history data such as behavior history data of another day, behavior history data of another person, or falsified behavior history data is prevented.

In step S539, the insurance money calculator 136 determines that the damage does not correspond to the compensation subject, and the compensation subject determination processing ends.

In FIG. 14 again, in step S504, the insurance money calculator 136 determines whether or not the damage corresponds to the compensation subject on the basis of a result of the processing of step S503. In a case where it is determined that the damage corresponds to the compensation subject, the processing proceeds to step S505.

In step S505, the insurance money calculator 136 provides notification that the damage corresponds to the compensation subject. Specifically, the insurance money calculator 136 transmits, to the user terminal 15, data providing the notification that the damage corresponds to the compensation subject.

In step S506, the insurance money calculator 136 executes insurance money calculation processing.

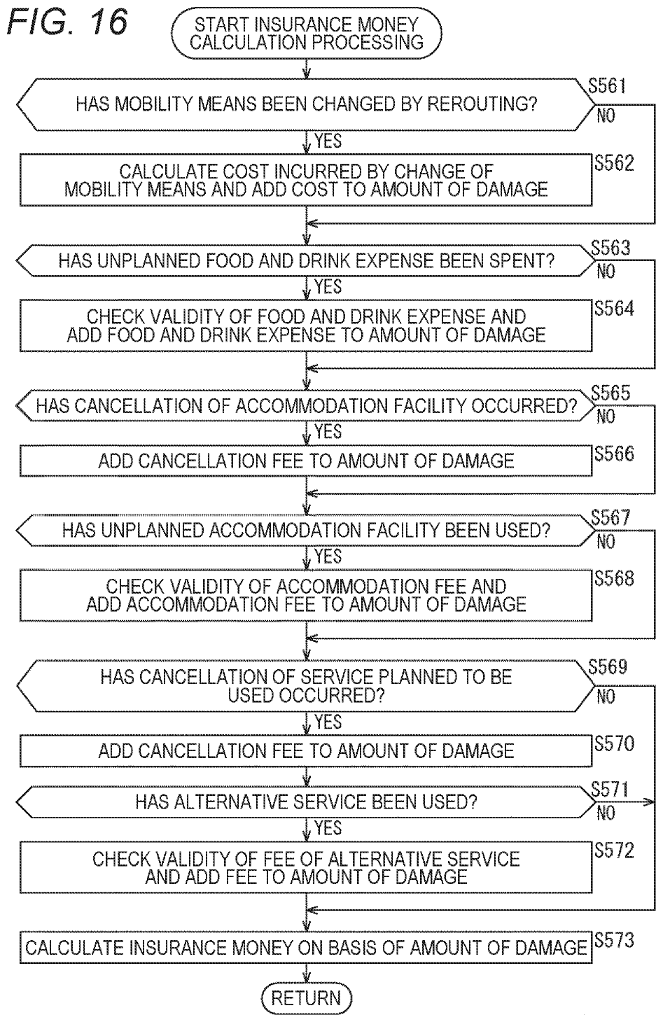

Here, details of the insurance money calculation processing will be described with reference to a flowchart of FIG. 16.

In step S561, the insurance money calculator 136 determines whether or not the mobility means has been changed by rerouting. Specifically, the insurance money calculator 136 confirms the content of the use history of the MaaS service to be a subject of the insurance money on the basis of the use history of the MaaS service of the user stored in the user DB 104. Then, in a case where the insurance money calculator 136 determines that the mobility means has been changed by rerouting, the processing proceeds to step S562.

In step S562, the insurance money calculator 136 calculates a cost incurred by the change of the mobility means and adds the cost to an amount of the damage. Specifically, the insurance money calculator 136 confirms the content of the content of the change of the mobility means caused during use of the MaaS service to be a subject of the insurance money on the basis of the use history of the MaaS service of the user stored in the user DB 104. The insurance money calculator 136 calculates the cost incurred by the change of the mobility means on the basis of the information stored in the traffic information DB 12. The cost incurred by the change of the mobility means includes, for example, a cancellation fee of the mobility means before the change and a fee of the mobility means after the change. The insurance money calculator 136 adds the calculated cost to the amount of the damage.

Thereafter, the processing proceeds to step S563.

On the other hand, in a case where it is determined in step S561 that the mobility means is not changed by rerouting, the processing of step S562 is skipped, and the processing proceeds to step S563.

In step S563, the insurance money calculator 136 determines whether or not unplanned food and drink expense has been spent on the basis of the unplanned cost data acquired from the user terminal 15. In a case where it is determined that the unplanned food and drink expense has been spent, the processing proceeds to step S564.

In step S564, the insurance money calculator 136 checks validity of the food and drink expense and adds the food and drink expense to the amount of the damage. For example, the insurance money calculator 136 sets an upper limit value of the unplanned food and drink expense on the basis of a time zone and place of the unplanned food and drink, the grade of the MaaS insurance with which the user has a contract, and the like. Note that, for example, in a case where it is determined that the place, the time zone, or the like of the unplanned food and drink is inappropriate, the insurance money calculator 136 sets the upper limit value to 0 yen.

In a case where the unplanned food and drink expense is less than or equal to the set upper limit value, the insurance money calculator 136 determines that the food and drink expense is valid, and adds the food and drink expense to the amount of the damage as it is. On the other hand, in a case where the unplanned food and drink expense is greater than the set upper limit value, the insurance money calculator 136 determines that the food and drink expense is invalid, and adds the set upper limit value to the amount of the damage.

Thereafter, the processing proceeds to step S565.

On the other hand, in a case where it is determined in step S563 that the unplanned food and drink expense has not been spent, the processing of step S564 is skipped, and the processing proceeds to step S565.

In step S565, the insurance money calculator 136 determines whether or not cancellation of the accommodation facility has occurred on the basis of the content of the use history of the MaaS service to be a subject of the insurance money. In a case where it is determined that cancellation of the accommodation facility has occurred, the processing proceeds to step S566.

In step S566, the insurance money calculator 136 adds a cancellation fee to the amount of the damage. Specifically, the insurance money calculator 136 confirms the cancellation fee of the canceled accommodation facility on the basis of the information stored in the accommodation facility DB 14, and adds the cancellation fee to the amount of the damage.

Thereafter, the processing proceeds to step S567.

On the other hand, in a case where it is determined in step S565 that the cancellation of the accommodation facility has not occurred, the processing in step S566 is skipped, and the processing proceeds to step S567.

In step S567, the insurance money calculator 136 determines whether or not an unplanned accommodation facility has been used on the basis of the unplanned cost data acquired from the user terminal 15. In a case where it is determined that the unplanned accommodation facility has been used, the processing proceeds to step S568.

In step S568, the insurance money calculator 136 checks validity of an accommodation fee and adds the accommodation fee to the amount of the damage. For example, on the basis of the information stored in the accommodation facility DB 14, the insurance money calculator 136 searches a market rate of an accommodation fee around the accommodation facility of the unplanned accommodation. Then, the insurance money calculator 136 sets an upper limit value of the accommodation fee of the unplanned accommodation facility on the basis of the market rate around accommodation facility, the accommodation fee of the canceled accommodation facility, the grade of the MaaS insurance with which the user has a contract, and the like. Note that, for example, in a case where it is determined that a location or the like of the unplanned accommodation is inappropriate, the insurance money calculator 136 sets the upper limit value to 0 yen.

In a case where the accommodation fee is less than or equal to the set upper limit value, the insurance money calculator 136 determines that the accommodation fee is valid, and adds the accommodation fee to the amount of the damage as it is. On the other hand, in a case where the accommodation fee is greater than the set upper limit value, the insurance money calculator 136 determines that the accommodation fee is invalid, and adds the set upper limit value to the amount of the damage.

Thereafter, the processing proceeds to step S569.

On the other hand, in a case where it is determined in step S567 that the unplanned accommodation facility has not been used, the processing of step S568 is skipped, and the processing proceeds to step S569.

In step S569, the insurance money calculator 136 determines whether or not cancellation of the service planned to be used has occurred on the basis of the content of the use history of the MaaS service to be a subject of the insurance money. In a case where it is determined that cancellation of the service planned to be used has occurred, the processing proceeds to step S570.

In step S570, the insurance money calculator 136 adds a cancellation fee to the amount of the damage. Specifically, the insurance money calculator 136 confirms the cancellation fee of the canceled service on the basis of the information stored in the service DB 13, and adds the cancellation fee to the amount of the damage.

In step S571, the insurance money calculator 136 determines whether or not an alternative service has been used on the basis of the unplanned cost data acquired from the user terminal 15. In a case where it is determined that the alternative service has been used, the processing proceeds to step S572.

In step S572, the insurance money calculator 136 checks validity of a fee of the alternative service and adds the fee to the amount of the damage. For example, the insurance money calculator 136 searches a market price of a service similar to the canceled service on the basis of the information stored in the service DB 13. In addition, the insurance money calculator 136 searches a similarity between the canceled service and the alternative service. Then, the insurance money calculator 136 sets an upper limit value of the fee of the alternative service on the basis of the fee of the canceled service, the market price of the fee of the similar service, the similarity between the canceled service and the alternative service, and the like.

Note that, for example, the more similar the canceled service and the alternative service, the higher the upper limit value, and the less similar the canceled service and the alternative service, the lower the upper limit value. Furthermore, for example, in a case where determining that the content, place, time zone, and the like of the alternative service are inappropriate, the insurance money calculator 136 sets the upper limit value to 0 yen.

In a case where the fee of the alternative service is less than or equal to the set upper limit value, the insurance money calculator 136 determines that the fee is valid, and adds the fee to the amount of the damage as it is. On the other hand, in a case where the fee of the alternative service is greater than the set upper limit value, the insurance money calculator 136 determines that the fee is invalid, and adds the set upper limit value to the amount of the damage.

Thereafter, the processing proceeds to step S573.

On the other hand, in a case where it is determined in step S571 that the alternative service has not been used, the processing of step S572 is skipped, and the processing proceeds to step S573.

Furthermore, in a case where it is determined in step S569 that cancellation of the service planned to be used has not occurred, the processing in steps S570 to S572 is skipped, and the processing proceeds to step S573.

In step S573, the insurance money calculator 136 calculates insurance money on the basis of the amount of the damage. For example, the insurance money calculator 136 calculates an amount of a predetermined rate of the amount of the damage as the insurance money to be paid to the user on the basis of the contract content of the MaaS insurance of the user. This contract content includes whether or not the insurance is applied for every section (mobility means) within the contract route.

Furthermore, the insurance money calculator 136 sets an upper limit value of the insurance money on the basis of the contract content of the MaaS insurance of the user, and corrects the insurance money to the upper limit value in a case where the calculated insurance money exceeds the upper limit value.

Thereafter, the insurance money calculation processing ends.

In FIG. 14 again, in step S507, the server 11 presents the insurance money. Specifically, the UI controller 231 controls the user terminal 15 to display a screen for presenting the calculated insurance money.

In step S508, the server 11 performs insurance money payment processing. Specifically, the insurance money calculator 136 performs processing necessary for payment of the insurance money in response to processing of receiving the insurance money by the user terminal 15 in FIG. 13.

Thereafter, the insurance money claim processing ends.

On the other hand, in a case where it is determined in step S504 that the damage does not correspond to the compensation subject, the processing proceeds to step S509.

In step S505, the insurance money calculator 136 provides notification that the damage does not correspond to the compensation subject. Specifically, the insurance money calculator 136 transmits, to the user terminal 15, data providing the notification that the damage does not correspond to the compensation subject.

Thereafter, the insurance money claim response processing ends.

<Second Embodiment of Service Use Processing>

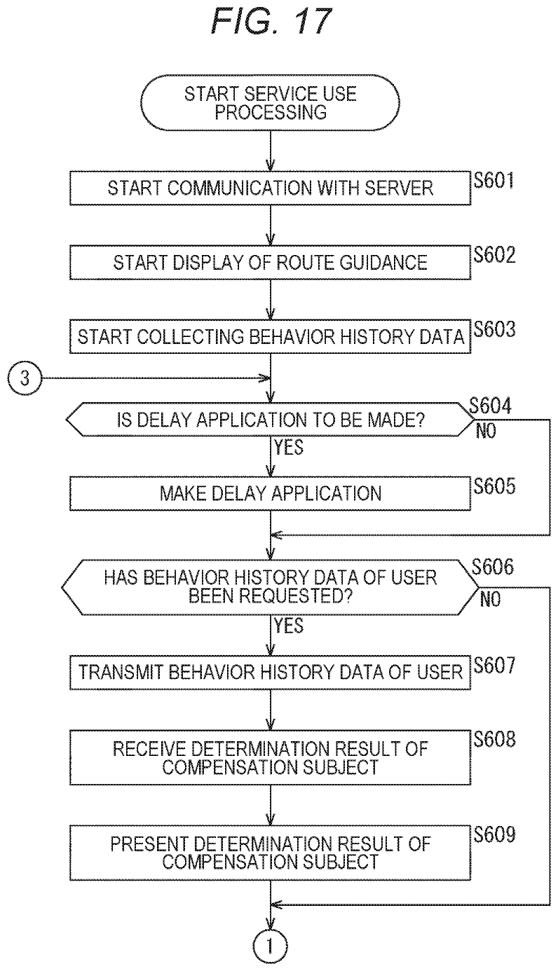

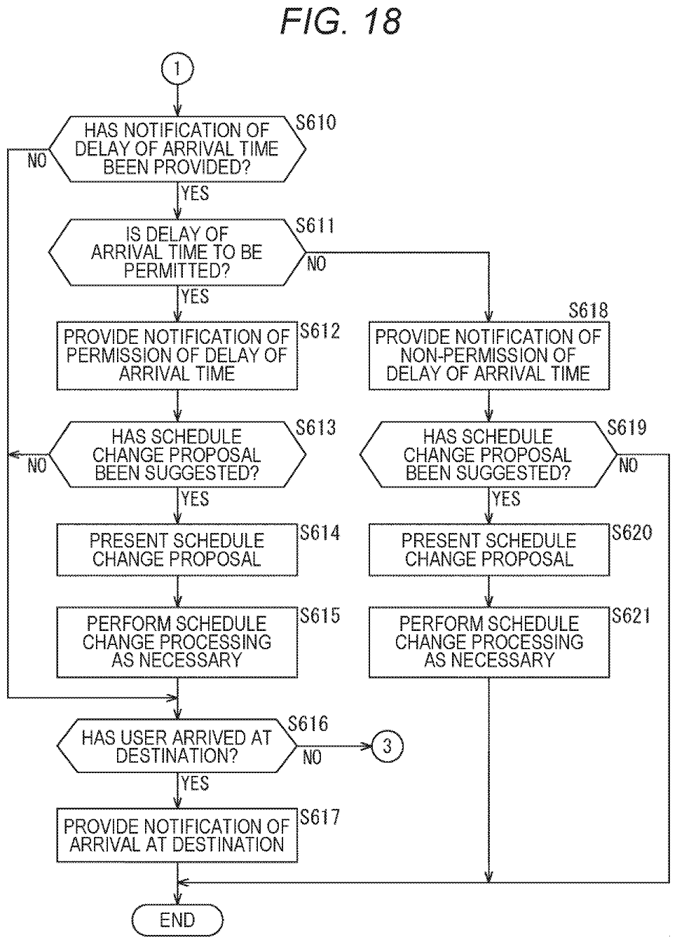

Next, a second embodiment of the service use processing executed by the user terminal 15 will be described with reference to flowcharts of FIGS. 17 and 18.

Note that, in the second embodiment, in a case where a delay occurs while the user is traveling, the server 11 can confirm whether or not the delay is the compensation subject.

In steps S601 to S603, processing similar to the processing in steps S201 to S203 in FIG. 8 is executed.

In step S604, the UI controller 231 determines whether or not to make a delay application.

For example, in a case where a delay of the mobility means occurs and it is determined that it is difficult to arrive at the destination by the target time, the user performs an operation for making a delay application for notifying the server 11 that the delay has occurred by using the operation unit 204.

In response to the above, the UI controller 231 determines to make the delay application, and the processing proceeds to step S605.

In step S605, the UI controller 231 makes the delay application. Specifically, the UI controller 231 transmits, to the server 11, data indicating the delay application.

Thereafter, the processing proceeds to step S606.

On the other hand, in a case where it is determined in step S604 not to make the delay application, the processing of step S605 is skipped, and the processing proceeds to step S606.

In step S606, the data generator 232 determines whether or not the behavior history data of the user has been requested.

As described later, in a case where the delay application is made by the user terminal 15 or in a case where it is determined that the current route does not allow arrival at the destination by the target time, the server 11 requests the user terminal 15 to transmit the behavior history data of the user.

In response to the above, the data generator 232 determines that the behavior history data of the user has been requested, and the processing proceeds to step S607.

In step S607, the data generator 232 transmits the behavior history data of the user.

Specifically, the data generator 232 reads historical behavior history data from the storage 203.

In addition, the user inputs the mobility means report data as necessary similarly to the processing of step S403 in FIG. 13 described above.

The data generator 232 adds mobility means report data to the acquired behavior history data as necessary, and transmits the data to the server 11.

In response to the above, the server 11 determines whether or not the delay currently occurring corresponds to the compensation subject on the basis of the behavior history data, and transmits data indicating a determination result to the user terminal 15.

In step S608, the user terminal 15 receives the determination result of the compensation subject. Specifically, the UI controller 231 receives, from the server 11, data indicating the determination result of the compensation subject.

In step S609, the user terminal 15 presents the determination result of the compensation subject. Specifically, the display 205 displays a screen indicating the determination result of the compensation subject under the control of the UI controller 231.

Thereafter, the processing proceeds to step S610.

On the other hand, in a case where it is determined in step S606 that the behavior history data of the user has not been requested, the processing of steps S607 to S609 is skipped, and the processing proceeds to step S610.

In steps S610 to S615, processing similar to the processing of steps S204 to S209 in FIG. 8 is performed.

In step S616, similarly to the processing of step S210 in FIG. 8, it is determined whether or not the user has arrived at the destination. In a case where it is determined that the user has not arrived at the destination, the processing returns to step S604.

Thereafter, the processing of steps S604 to S616 is repeatedly executed until it is determined in step S616 that the user has arrived at the destination or it is determined not to permit the delay of the arrival time in step S611.

On the other hand, in a case where it is determined in step S616 that the user has arrived at the destination, the processing proceeds to step S617.

In step S617, similarly to the process of step S211 in FIG. 8, the notification of the arrival at the destination is provided, and the service use processing ends.

On the other hand, in a case where it is determined in step S611 not to permit the delay of the arrival time, the processing proceeds to step S618.

Thereafter, in steps S618 to S621, processing similar to the processing in steps S212 to S215 is performed, and then the service use processing ends.

<Second Embodiment of Service Providing Processing>

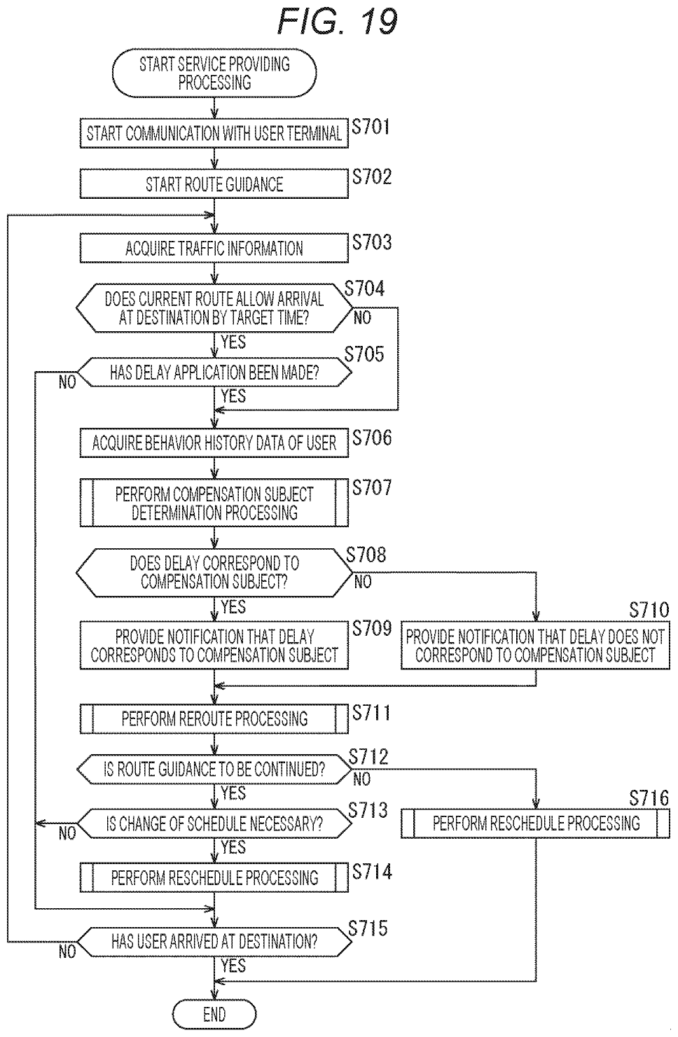

Next, a second embodiment of the service providing processing executed by the server 11 in response to the service use processing executed by the user terminal 15 in FIGS. 17 and 18 will be described with reference to a flowchart of FIG. 19.

In steps S701 to S703, processing similar to the processing in steps S301 to S303 in FIG. 9 is executed.

In step S704, similarly to the processing of step S304 in FIG. 9, it is determined whether or not the current route allows arrival at the destination by the target time. In a case where it is determined that the current route allows arrival at the destination by the target time, the processing proceeds to step S705.

In step S705, the route setting unit 134 determines whether or not the delay application has been made. In a case where receiving the data indicating the delay application transmitted from the user terminal 15 in the processing of step S605 in FIG. 17 described above, the route setting unit 134 determines that the delay application has been made, and the processing proceeds to step S706.

On the other hand, in a case where it is determined in step S704 that the current route does not allow arrival at the destination by the target time, the processing of step S705 is skipped, and the process proceeds to step S706.

In step S706, the insurance money calculator 136 acquires the behavior history data of the user. Specifically, the insurance money calculator 136 requests the user terminal 15 to transmit the behavior history data of the user.

In response to the above, the user terminal 15 generates the behavior history data of the user and transmits the behavior history data to the server 11 in step S607 in FIG. 16 described above.

The insurance money calculator 136 receives the behavior history data transmitted from the user terminal 15.

In step S707, the compensation subject determination processing is executed similarly to the processing of step S503 in FIG. 14.

In step S708, similarly to the processing of step S504 in FIG. 14, it is determined whether or not the delay corresponds to the compensation subject. In a case where it is determined that the delay corresponds to the compensation subject, the processing proceeds to step S709.

In step S709, similarly to the processing of step S505 in FIG. 14, the user terminal 15 is notified of the fact that the delay corresponds to the compensation subject.

Thereafter, the processing proceeds to step S711.

On the other hand, in a case where it is determined in step S708 that the delay does not correspond to the compensation subject, the processing proceeds to step S710.

In step S710, similarly to the processing of step S509 in FIG. 14, the user terminal 15 is notified of the fact that the delay corresponds to the compensation subject.

Thereafter, the processing proceeds to step S711.

In steps S711 to S714, processing similar to the processing in steps S306 to S308 in FIG. 9 is executed.

On the other hand, in a case where it is determined in step S705 that the delay application has not been made, the processing of steps S706 to S714 is skipped, and the processing proceeds to step S715.

In a case where it is determined in step S715 whether or not the user has arrived at the destination, similarly to the processing of step S309 in FIG. 9. In a case where it is determined that the user has not arrived at the destination yet, the processing returns to step S703.

Thereafter, the processing of steps S703 to S715 is repeatedly executed until it is determined in step S715 that the user has arrived at the destination.

On the other hand, in a case where it is determined in step S715 that the user has arrived at the destination, the service providing processing ends.

As described above, the MaaS insurance applicable to the MaaS service can be provided.

For example, the MaaS insurance is flexibly designed in accordance with the route set by the MaaS service, and moreover, the user can select whether or not to purchase the insurance for every section (mobility means). In addition, it is possible to provide two types of insurance of the accident compensation insurance and the delay compensation insurance. As a result, insurance can be provided in accordance with needs of the user, a satisfaction level of the user can be improved.

For example, it is determined whether or not the delay is the compensation subject on the basis of the behavior history data of the user and the reliability of the behavior history data. As a result, particularly in the delay compensation insurance, it is possible to prevent a fraudulent act of illegally acquiring insurance money.

### 2. Modifications

Hereinafter, modifications of the above-described embodiments of the present technology will be described.

Note that, in the above description, a method of calculating the insurance premium of the delay compensation MaaS insurance has been described. However, the insurance premium of the accident compensation MaaS insurance is calculated on the basis of, for example, an accident occurrence rate of each mobility means or the like.

For example, in the example of FIG. 5, a base insurance premium is calculated for the section between the point A and the point B on the basis of years of possession of the license of the user, a history of accidents caused by the user in the past, the compensation content, and the like. Furthermore, for example, an insurance premium is added on the basis of the accident occurrence rate or the like in the section.

For the section between the point B and the point C, the base insurance premium is calculated on the basis of an occurrence rate of accidents of airplanes, the compensation content, and the like. Furthermore, for example, an insurance premium is added on the basis of the accident occurrence rate or the like in the section (in a track).

For the section between the point C and the point D, the base insurance premium is calculated on the basis of an occurrence rate of accidents of route buses, the compensation content, and the like. Furthermore, for example, an insurance premium is added on the basis of the accident occurrence rate or the like in the section.

For the section between the point E and the point F, the base insurance premium is calculated on the basis of an occurrence rate of accidents of pedestrian, the compensation content, and the like. Furthermore, for example, an insurance premium is added on the basis of the accident occurrence rate or the like in the section.

In this way, the insurance premium individually calculated for every section (for every mobility means) is added for the section for which the user desires to purchase the insurance.

Note that the base insurance premium may be determined, for example, by reading a value registered in advance in the corresponding element of a multidimensional matrix regarding a parameter from a combination of parameter values, or may be calculated by a function determined in advance using the parameters as arguments. The function is, for example, a weighted summation of parameter values in some cases.

For example, in a case where the mobility means in the section covered by the accident compensation insurance is changed by rerouting, the accident compensation insurance may be handed over to the mobility means after the change without an additional fee or the like. Alternatively, for example, the user may select whether or not to purchase the accident compensation insurance of the mobility means after the change. In this case, for example, a difference between the insurance premium for the mobility means before the change and the insurance premium for the mobility means after the change may be refunded to the user or collected from the user.

In the compensation subject determination processing of FIG. 15, an example has been described in which an act estimated as a fraudulent act is unconditionally excluded from the compensation subject upon detection. That is, an example has been described in which a rate for compensation for caused damage is set to 0. On the other hand, for example, the rate of compensation for caused damage may be set (varied) in accordance with a degree of the act estimated as a fraudulent act. As a result, for example, the insurance money decreases as the fraudulent act is more suspicious, and the insurance money increases as the fraudulent act is less suspicious.

In the above description, an example has been described in which the server 11 provides both the MaaS service and the MaaS insurance. However, for example, a server that provides the MaaS service and a server that provides the MaaS insurance may be separated.

In the above description, an example has been described in which the server 11 only suggests the alternative service and the alternative accommodation facility. However, for example, the server 11 may also perform the arrangement processing for the alternative service and the alternative accommodation facility.

For example, the server 11 may create not only a route but also a schedule of the user (for example, reserve a service or an accommodation facility to be used, or the like).

### 3. Others

The above series of processing can be executed by hardware or software.

Note that the program executed by the computer may be a program in which processing is performed in time series in the order herein described, or may be a program in which processing is performed in parallel or at necessary timing such as when a call is made.

In addition, a system herein described means a set of a plurality of components (devices, modules (parts), and the like), and it does not matter whether or not all the components are in the same housing. Therefore, a plurality of devices accommodated in separate housings and connected via a network and one device in which a plurality of modules is accommodated in one housing are both systems.

Furthermore, the embodiments of the present technology are not limited to the above-described embodiments, and various modifications can be made without departing from the gist of the present technology.

For example, the present technology can have a configuration of cloud computing in which one function is shared and processed in cooperation by a plurality of devices via a network.

Furthermore, each step described in the above-described flowchart can be executed by one device or can be shared and executed by a plurality of devices.

Moreover, in a case where a plurality of processing is included in one step, the plurality of processing included in the one step can be executed by one device or can be shared and executed by a plurality of devices.

<Example of Combination of Configurations>

The present technology can also employ the following configurations.
(1) An information processing apparatus includes an insurance money calculator that calculates insurance money on the basis of a contract content of an insurance that compensates for damage occurring on a route combining a plurality of mobility means and on the basis of actual damage.
(2) In the information processing apparatus according to (1), the damage occurring on the route includes at least one of damage occurring due to a delay of a mobility means or damage occurring due to an accident of an insured person.
(3) The information processing apparatus according to (2) further includes a route setting unit that changes the route in response to the delay of the mobility means within the route.
(4) In the information processing apparatus according to (3), the route setting unit changes the route to another route that allows arrival at a destination by a target time.
(5) In the information processing apparatus according to (3) or (4), the route setting unit performs processing related to at least one of cancellation of the mobility means within the route before the route is changed or arrangement of the mobility means within the route after the route is changed.
(6) In the information processing apparatus according to any one of (3) to (5), the insurance money calculator calculates the insurance money on the basis of damage caused by a change of the route.
(7) The information processing apparatus according to any one of (2) to (6) further includes a schedule setting unit that changes a schedule of the insured person in response to the delay of the mobility means within the route.
(8) In the information processing apparatus according to (7), the schedule setting unit changes at least one of a service or an accommodation facility to be used by the insured person.
(9) In the information processing apparatus according to (8), the schedule setting unit performs processing related to at least one of cancellation of a service, suggestion of a service, arrangement of a service, cancellation of an accommodation facility, suggestion of an accommodation facility, or arrangement of an accommodation facility in accordance with a change of the schedule.
(10) In the information processing apparatus according to any one of (7) to (9), the insurance money calculator calculates the insurance money on the basis of damage caused by the change of the schedule of the insured person.
(11) In the information processing apparatus according to any one of (2) to (10), the insurance money calculator sets a rate of compensation for the actual damage on the basis of behavior history data related to a behavior of the insured person while the insured person is traveling in accordance with the route.
(12) In the information processing apparatus according to (11), the insurance money calculator sets the rate of the compensation for the actual damage on the basis of at least one of reliability of the behavior history data or the behavior of the insured person, the behavior being estimated by the behavior history data.
(13) In the information processing apparatus according to (12), the insurance money calculator sets, on the basis of the behavior history data, the rate of the compensation for the actual damage on the basis of a result of estimation of at least one of a path on which the insured person has traveled, a place at which the insured person has stayed, a time during which the insured person has stayed, or a mobility means actually used by the insured person.
(14) The information processing apparatus according to any one of (11) to (13) further includes a communication controller that controls reception of the behavior history data from an information processing terminal used by the insured person.
(15) The information processing apparatus according to any one of (1) to (14) further includes an insurance designer that designs the insurance corresponding to the route.
(16) In the information processing apparatus according to (15), the insurance designer designs the insurance to be applied to a mobility means selected from among the mobility means within the route.
(17) The information processing apparatus according to (16) further includes a terminal controller that controls a user interface of an information processing terminal used for applying the insurance so that a mobility means to which the insurance is applied is selected from among the mobility means within the route.
(18) In the information processing apparatus according to (16) or (17), the insurance designer calculates an insurance premium on the basis of whether or not the insurance is applied to each of the mobility means within the route, and the insurance money calculator calculates the insurance money on the basis of whether or not the insurance is applied to each of the mobility means within the route.
(19) An information processing method includes calculating, by an information processing apparatus, insurance money on the basis of a contract content of an insurance that compensates for damage occurring on a route combining a plurality of mobility means and on the basis of actual damage.
(20) A program causes a computer to execute processing including calculating insurance money on the basis of a contract content of an insurance that compensates for damage occurring on a route combining a plurality of mobility means and on the basis of actual damage.
(21) An information processing terminal includes a communication controller that controls communication with an information processing apparatus that calculates insurance money on the basis of a contract content of an insurance that compensates for damage occurring on a route combining a plurality of mobility means and on the basis of actual damage, and a user interface controller that controls presentation of the insurance money calculated by the information processing apparatus.
(22) The information processing terminal according to claim (21) further includes a data generator that generates behavior history data related to a behavior of an insured person while the insured person is traveling in accordance with the route, in which the communication controller controls transmission of the behavior history data to the information processing apparatus.
(23) In the information processing terminal according to (21) or (22), the user interface controller controls a user interface used for applying the insurance so that a mobility means to which the insurance is applied is selected from among the mobility means within the route.
(24) An information processing method includes controlling, by an information processing terminal, communication with an information processing apparatus that calculates insurance money on the basis of a contract content of an insurance that compensates for damage occurring on a route combining a plurality of mobility means and on the basis of actual damage, and controlling, by the information processing terminal, presentation of the insurance money calculated by the information processing apparatus.
(25) A program causes a computer to execute processing including controlling communication with an information processing apparatus that calculates insurance money on the basis of a contract content of an insurance that compensates for damage occurring on a route combining a plurality of mobility means and on the basis of actual damage, and controlling presentation of the insurance money calculated by the information processing apparatus.
(26) An information processing system includes an information processing apparatus and an information processing terminal, in which the information processing apparatus includes an insurance money calculator that calculates insurance money on the basis of a contract content of an insurance that compensates for damage occurring on a route combining a plurality of mobility means and on the basis of actual damage, and a first communication controller that controls communication with the information processing terminal, and the information processing terminal includes a second communication controller that controls communication with the information processing apparatus, and a user interface controller that controls presentation of the insurance money calculated by the information processing apparatus.

Note that the effects herein described are merely examples and are not limited, and furthermore, other effects may be obtained.

### REFERENCE SIGNS LIST

1 Information processing system
11 Server
12 Traffic information DB
13 Service DB
14 Accommodation facility DB
15-1 to 15-n User terminal
101 CPU
104 User DB
105 Route DB
106 Insurance DB
109 Communication unit
133 Schedule setting unit
134 Route setting unit
135 Insurance designer
136 Insurance money calculator
137 UI controller
138 Communication controller
201 CPU
205 Display
207 Camera
208 Sensing unit
209 Communication unit

1. An information processing apparatus comprising an insurance money calculator that calculates insurance money on a basis of a contract content of an insurance that compensates for damage occurring on a route combining a plurality of mobility means and on a basis of actual damage.

2. The information processing apparatus according to claim 1, wherein the damage occurring on the route includes at least one of damage occurring due to a delay of a mobility means or damage occurring due to an accident of an insured person.

3. The information processing apparatus according to claim 2, further comprising a route setting unit that changes the route in response to the delay of the mobility means within the route.

4. The information processing apparatus according to claim 3, wherein the route setting unit changes the route to another route that allows arrival at a destination by a target time.

5. The information processing apparatus according to claim 3, wherein the route setting unit performs processing related to at least one of cancellation of the mobility means within the route before the route is changed or arrangement of the mobility means within the route after the route is changed.

6. The information processing apparatus according to claim 3, wherein the insurance money calculator calculates the insurance money on a basis of damage caused by a change of the route.

7. The information processing apparatus according to claim 2, further comprising a schedule setting unit that changes a schedule of the insured person in response to the delay of the mobility means within the route.

8. The information processing apparatus according to claim 7, wherein the schedule setting unit changes at least one of a service or an accommodation facility to be used by the insured person.

9. The information processing apparatus according to claim 8, wherein the schedule setting unit performs processing related to at least one of cancellation of a service, suggestion of a service, arrangement of a service, cancellation of an accommodation facility, suggestion of an accommodation facility, or arrangement of an accommodation facility in accordance with a change of the schedule.

10. The information processing apparatus according to claim 7, wherein the insurance money calculator calculates the insurance money on a basis of damage caused by the change of the schedule of the insured person.

11. The information processing apparatus according to claim 2, wherein the insurance money calculator sets a rate of compensation for the actual damage on a basis of behavior history data related to a behavior of the insured person while the insured person is traveling in accordance with the route.

12. The information processing apparatus according to claim 11, wherein the insurance money calculator sets the rate of the compensation for the actual damage on a basis of at least one of reliability of the behavior history data or the behavior of the insured person, the behavior being estimated by the behavior history data.

13. The information processing apparatus according to claim 12, wherein the insurance money calculator sets, on a basis of the behavior history data, the rate of the compensation for the actual damage on a basis of a result of estimation of at least one of a path on which the insured person has traveled, a place at which the insured person has stayed, a time during which the insured person has stayed, or a mobility means actually used by the insured person.

14. The information processing apparatus according to claim 11, further comprising a communication controller that controls reception of the behavior history data from an information processing terminal used by the insured person.

15. The information processing apparatus according to claim 1, further comprising an insurance designer that designs the insurance corresponding to the route.

16. The information processing apparatus according to claim 15, wherein the insurance designer designs the insurance to be applied to a mobility means selected from among the mobility means within the route.

17. The information processing apparatus according to claim 16, further comprising a terminal controller that controls a user interface of an information processing terminal used for applying the insurance so that a mobility means to which the insurance is applied is selected from among the mobility means within the route.

18. The information processing apparatus according to claim 16, wherein
the insurance designer calculates an insurance premium on a basis of whether or not the insurance is applied to each of the mobility means within the route, and
the insurance money calculator calculates the insurance money on a basis of whether or not the insurance is applied to each of the mobility means within the route.

19. An information processing method comprising calculating, by an information processing apparatus, insurance money on a basis of a contract content of an insurance that compensates for damage occurring on a route combining a plurality of mobility means and on a basis of actual damage.

20. A program that causes a computer to execute processing including calculating insurance money on a basis of a contract content of an insurance that compensates for damage occurring on a route combining a plurality of mobility means and on a basis of actual damage.

21. An information processing terminal comprising:
a communication controller that controls communication with an information processing apparatus that calculates insurance money on a basis of a contract content of an insurance that compensates for damage occurring on a route combining a plurality of mobility means and on a basis of actual damage; and
a user interface controller that controls presentation of the insurance money calculated by the information processing apparatus.

22. The information processing terminal according to claim 21, further comprising a data generator that generates behavior history data related to a behavior of an insured person while the insured person is traveling in accordance with the route, wherein the communication controller controls transmission of the behavior history data to the information processing apparatus.

23. The information processing terminal according to claim 21, wherein the user interface controller controls a user interface used for applying the insurance so that a mobility means to which the insurance is applied is selected from among the mobility means within the route.

24. An information processing method comprising:
controlling, by an information processing terminal, communication with an information processing apparatus that calculates insurance money on a basis of a contract content of an insurance that compensates for damage occurring on a route combining a plurality of mobility means and on a basis of actual damage; and
controlling, by the information processing terminal, presentation of the insurance money calculated by the information processing apparatus.

25. A program that causes a computer to execute processing including
controlling communication with an information processing apparatus that calculates insurance money on a basis of a contract content of an insurance that compensates for damage occurring on a route combining a plurality of mobility means and on a basis of actual damage, and
controlling presentation of the insurance money calculated by the information processing apparatus.

26. An information processing system comprising:
an information processing apparatus; and
an information processing terminal, wherein
the information processing apparatus includes
an insurance money calculator that calculates insurance money on a basis of a contract content of an insurance that compensates for damage occurring on a route combining a plurality of mobility means and on a basis of actual damage, and
a first communication controller that controls communication with the information processing terminal, and
the information processing terminal includes
a second communication controller that controls communication with the information processing apparatus, and
a user interface controller that controls presentation of the insurance money calculated by the information processing apparatus.
